(19) United States
(12) Patent Application Publication
(10) Pub. No.: US 2026/0076317 A1
(43) Pub. Date: Mar. 19, 2026

(54) SYSTEMS AND METHODS FOR FABRICATION, MAINTENANCE, AND REPAIR OF SYNTHETIC LIVING WOOD TISSUE

(71) Applicant: Hila Shimshi, San Anselmo, CA (US)

(72) Inventor: Hila Shimshi, San Anselmo, CA (US)

(21) Appl. No.: 19/396,171

(22) Filed: Nov. 20, 2025

Related U.S. Application Data
(60) Provisional application No. 63/724,125, filed on Nov. 22, 2024.
(60) Provisional application No. 63/810,638, filed on May 22, 2025.

(51) Int. Cl. A01G 24/60; A01G 24/40; B29C 64/165; B29C 73/16; B33Y 10/00; B33Y 30/00; B33Y 70/10

(52) U.S. Cl. CPC A01G 24/60; A01G 24/40; B29C 64/165; B29C 73/16; B33Y 10/00; B33Y 30/00; B33Y 70/10

(57) ABSTRACT

The invention provides an integrated system and method for fabricating, regenerating, and maintaining synthetic living wood tissue constructs. The platform utilizes a formulation subsystem that prepares plant-derived precursor cells, lineage-directing Exomix signaling vesicles, and a supportive cellulose-based hydrogel into a printable bio-ink. An additive biofabrication subsystem generates structured constructs containing organized cambial, xylem, and phloem domains, microfluidic vascular channels, and embedded niche reservoirs. A maintenance and repair subsystem preserves tissue viability, delivers targeted regeneration cues, and supports long-term integration with damaged or aging wood substrates. Environmental control modules regulate electrical, mechanical, thermal, and biochemical parameters to guide differentiation and maturation. The invention enables sustainable production of regenerative wood materials with enhanced strength, decay resistance, and customizable properties, addressing limitations of natural wood through controlled biomanufacturing and restoration workflows.

### CROSS REFERENCE TO RELATED APPLICATIONS

This utility patent application claims the priority dates and benefits of patent applications 63/810,638 filed on 22 May 2025 and 63/724,125 filed on 22 Nov. 2024. The contents of which are incorporated by reference herein as if restated in this patent application.

### BACKGROUND

The present invention relates to regenerative biomaterials and methods for producing them. More particularly, it concerns composite materials comprising differentiated plant or plant-derived cells, extracellular vesicles secreted by such cells, and a biocompatible scaffold matrix that together promote structural and functional regeneration of biological or engineered tissues.

Conventional wood products are subject to decay of dead wood tissue, which significantly reduces the longevity and durability of finished goods. Traditional preservation techniques, such as chemical treatments and surface coatings, have been employed to mitigate decay. However, these approaches often provide only temporary protection and may introduce environmental or health concerns due to the use of toxic substances. Furthermore, such methods do not fundamentally alter the underlying susceptibility of dead wood tissue to biological degradation, resulting in limited long-term effectiveness.

Existing methods for wood product fabrication have generally been limited in their ability to impart non-natural or enhanced properties to wood materials. While certain treatments can modify surface characteristics or improve resistance to specific environmental factors, these modifications are typically superficial and do not enable the integration of novel functionalities or substantial improvements in mechanical, optical, or biological properties. As a result, the range of applications for engineered wood products remains constrained by the inherent limitations of natural wood.

The sourcing of wood for manufacturing purposes has historically relied on the harvesting of mature trees from natural forests or plantations. This practice has contributed to unsustainable wood sourcing and deforestation, leading to significant ecological impacts such as loss of biodiversity, disruption of carbon cycles, and degradation of soil and water resources. Efforts to promote sustainable forestry and certification schemes have achieved only partial success, and the demand for wood products continues to place pressure on natural ecosystems.

Manufacturing processes for engineered wood products have often involved the use of adhesives, and other chemical agents that may pose environmental hazards. Many conventional processes generate significant waste and emissions, and the resulting products may not be biodegradable or recyclable. The need for environmentally friendly processes in engineered wood manufacturing remains unmet, as existing methods frequently fail to balance performance requirements with ecological considerations.

Current approaches in plant tissue engineering and wood product fabrication have not addressed the inability to sustain or regenerate living wood tissue in damaged or manufactured wood products. Once wood is harvested and processed, the tissue is no longer living, and the capacity for self-repair or regeneration is lost. This limitation restricts the potential for extending product lifespan, repairing damage, or restoring functionality in wood-based materials, thereby reducing the overall utility and sustainability of wood products.

Regenerative materials often rely on either cellular components (e.g., stem cells) or extracellular vesicles (EVs) as biological effectors. However, systems integrating differentiated cells and their corresponding EVs within a unified scaffold remain limited. Differentiated cells provide structural and enzymatic cues characteristic of mature tissue, while their EVs deliver molecular instructions, including RNAs, lipids, and proteins that guide repair and remodeling. Combining these components into a coherent biomaterial creates a self-regulating microenvironment that supports regeneration.

Wood products contain dead wood tissue that may be prone to decay and other type of damage, thus crippling the product's longevity. Wood products may benefit from non-natural wood properties. With the high and growing demand of wood products, it may be beneficial to devise a sustainable and environmentally friendly way to manufacture and sustain them.

### SUMMARY

In some aspects, the present disclosure resolves one or more of the aforementioned hardships.

The present inventions relate to method(s) (e.g., technique), device(s), apparatus(es), system(s), and design(s) associated with fabrication (e.g., manufacture) of a synthetic \ wood tissue, a wood tissue supplement (Exomix), or any combination thereof. In an example, the present inventions relate to method(s) (e.g., technique), device(s), apparatus(es), system(s), and design(s) associated with fabrication (e.g., manufacture) of a synthetic living wood tissue, a living wood tissue supplement (Exomix), or any combination thereof. The synthetic wood tissue can be utilized (a) to mend decayed and/or damaged wood tissue such as a dead tissue, or (b) to manufacture new products including the synthetic wood tissue. The synthetic wood tissue can extend the longevity of the wood product as compared to respective commercially available wood products. The technology disclosed herein relates to extending the (e.g., living) wood tissue over time. With relation to the wood products, the technology disclosed herein may facilitate revival, restoration, regeneration, integrity retainment, maintenance of wood properties, enhancement of wood properties, and/or adding artificial properties to wood products. Provided herein are living wood tissues synthesized with non-natural properties. Provided herein is a library of plant cells, a library of Exomix formulations, and/or a library of Extracellular Vesicles (EVs), which may be utilized for any of the above uses.

In one aspect, the invention provides a synthetic living wood tissue fabrication and restoration system that integrates multiple coordinated subsystems. The system includes a formulation-preparation subsystem configured to generate a bio-active plant-cell formulation referred to as an Exomix; an encapsulation unit for packaging the Exomix formulation into vesicles to enable controlled release; and an additive-manufacturing subsystem that deposits successive layers of the resulting bio-ink to form a synthetic living-wood tissue construct containing niche reservoirs and a microfluidic channel network.

The system may further comprises an environmental-control module that maintains temperature, humidity, and gas composition suitable for plant-cell viability during fabrication and post-fabrication maturation, and a maintenance-and-repair delivery subsystem operable to apply Exomix-containing material for post-fabrication maintenance. A control system with processing electronics and feedback circuitry coordinates operation of the foregoing subsystems to sustain a stable biomanufacturing environment.

In another aspect, the invention provides methods of fabricating and maintaining synthetic living wood tissue. The methods include preparing biological inputs such as pluripotent and differentiated plant cells together with an Exomix formulation; formulating a bio-ink by combining these biological inputs with a supportive hydrogel matrix and tuning viscosity to a printable range; and fabricating a living wood-tissue construct by depositing sequential layers under controlled temperature and humidity.

The methods may further include integrating the fabricated construct with a wood substrate, maintaining the construct by periodic supplementation with Exomix-rich medium through spraying, immersion, or infusion, and monitoring viability using impedance spectroscopy and chlorophyll-fluorescence analysis. Process variables are adjusted through feedback control to maintain metabolic activity and uniform tissue maturation.

In a further aspect, the invention provides synthetic living wood tissue constructs produced by the foregoing systems and methods. Each construct comprises living plant cells retained within a supportive matrix, discrete reservoirs containing Exomix formulations, and an interconnected microfluidic channel network that distributes nutrients and signaling vesicles. The constructs exhibit one or more living-cell functions selected from respiration, photosynthesis, and self-repair. In certain embodiments, the living plant cells include both pluripotent stem cells and differentiated xylem and phloem cells displaying lignified secondary-wall morphology or phloem-associated transport features.

In some aspects, the supportive matrix may include cellulose-nanofiber hydrogels or other biocompatible polymers configured to provide enhanced mechanical strength and resistance to decay.

These aspects, and other disclosed systems and methods collectively define an integrated platform for producing, maintaining, and restoring living wood-like materials that combine biological adaptability with engineered precision, providing practical applications in wood preservation, regenerative construction materials, and sustainable biomaterial manufacturing.

In some aspects, the presently disclosed embodiments may provide a composite biomaterial, “synthetic living wood tissue” comprising: (1) differentiated vascular-type cells, such as xylem-like and/or phloem-like cells exhibiting lignified or sieve-tube morphology; (2) extracellular vesicles (EVs) derived from said cells or from their progenitor populations, comprising lipid bilayer and monolayer vesicles containing proteins, RNAs, and metabolites associated with tissue repair or communication; and (3) a scaffold or matrix, optionally natural or synthetic, providing mechanical support and surface chemistry compatible with EV and cell integration. The combination of these elements yields a bioactive material capable of initiating or accelerating regeneration of plant, wood, or analogous tissues.

In some aspects, the synthetic living wood tissue fabrication and restoration system, together with the synthetic wood tissue fabrication and maintenance method, provides an integrated platform and process for producing, restoring, and maintaining synthetic living wood tissue construct. The synthetic living wood tissue fabrication and restoration system comprises a formulation preparation subsystem, a fabrication apparatus, a maintenance and repair delivery subsystem, and a control system, all configured to operate in a controlled process environment. The synthetic wood tissue fabrication and maintenance method utilizes a sequence of steps including the preparation of biological inputs, formulation of bio-ink and supplement mixtures, additive manufacturing of synthetic wood tissue, integration or repair of target structures, maintenance of living tissue, harvesting of secondary bioproducts, and continuous process monitoring and control. The invention enables the production of synthetic living wood tissue construct with tunable biological and physical properties, supporting both the fabrication of new wood-based materials and the restoration or enhancement of existing wood products.

In some aspects, the synthetic living wood tissue fabrication and restoration system addresses the problem of decay in dead wood tissue, which reduces product longevity, by enabling the fabrication and maintenance of synthetic living wood tissue construct that retain metabolic activity and self-repair capabilities. The synthetic plant tissue construct, produced via the additive manufacturing subsystem and maintained by the maintenance and repair delivery subsystem, incorporates a cellular matrix, niche reservoirs, and a microfluidic channel network, which collectively support ongoing tissue viability and function. The sensors array and feedback loop circuitry within the control system provide real-time monitoring and adaptive maintenance, configured to maintain structural integrity via adaptive repair mechanisms in the lifespan and durability of wood-based products compared to conventional, non-living wood materials.

In some aspects, the invention further solves the lack of methods to impart non-natural or enhanced properties to wood products by enabling the formulation and deposition of bio-ink and supplement mixtures containing engineered plant cell population, Exomix signaling cocktail, and supportive matrix materials. The formulation preparation subsystem, including the Exomix production module and encapsulation unit, allows for the generation and controlled delivery of synthetic or natural signaling factors, enabling the induction of targeted differentiation and the integration of non-native functionalities. The fabrication technique configuration and the use of synthetic-only signaling variant permit the customization of mechanical, chemical, and biological properties in the synthetic living wood tissue construct, surpassing the capabilities of traditional wood modification techniques.

In some aspects, to address the issue of unsustainable wood sourcing and deforestation, the synthetic living wood tissue fabrication and restoration system utilizes plant pluripotent cell supply and differentiated cell repository as renewable biological inputs, reducing reliance on harvested timber. The cell source module and cell library management components enable the expansion and differentiation of plant cell population in vitro, supporting the scalable production of wood tissue constructs without the need for large-scale logging. This approach provides a quantifiable reduction in raw wood consumption and associated environmental impact relative to conventional wood product manufacturing.

In some aspects, the invention also meets the need for environmentally friendly processes in engineered wood manufacturing by integrating a controlled process environment, environmental control module, and maintenance material preparation module. The system's ability to monitor and adjust temperature, humidity, and gas composition, combined with the use of bio-based and biodegradable materials in the supportive matrix and bio-ink, results in a process with reduced emissions, waste, and chemical usage. The harvesting of secondary bioproducts, such as biochemical extracts, further enhances resource efficiency and environmental compatibility compared to prior art.

In some aspects, the synthetic living wood tissue fabrication and restoration system overcomes the inability to sustain or regenerate living wood tissue in damaged or manufactured wood products by providing a maintenance and repair delivery subsystem capable of applying maintenance materials, and inducing integration and growth at the application site. The delivery mechanism, including spray/aerosol units, immersion chamber, and channel injection probe, enables precise and localized intervention, while the continuous monitoring of viability and function metrics data ensures the ongoing health and regenerative capacity of the synthetic living wood tissue construct. This capability represents a significant advancement over static, non-living engineered wood products, enabling the creation of self-sustaining, repairable, and adaptive wood-based materials.

In some aspects, the biomaterial comprises vascular-differentiated cells derived from undifferentiated or callus plant cells. Xylem-like cells may exhibit secondary wall thickening and lignin deposition, while phloem-like cells exhibit sieve-tube morphology and nutrient-transport structures. Differentiation may be induced by exposure to hormonal cues such as auxin and cytokinin, optionally combined with mechanical or light stimulation, or by co-culture with vascular-inductive tissue. The invention is not limited to any specific protocol; any method resulting in vascular-like differentiated cells is within scope.

In some aspects, the differentiated cells secrete EVs containing proteins, RNAs, and metabolites characteristic of their lineage. EVs may be harvested from conditioned medium or aqueous growth systems using filtration, tangential-flow filtration (TFF), size-exclusion chromatography (SEC), or equivalent isolation techniques. The EV fraction typically comprises particles of 20-1000 nm diameter with lipid bilayers and/or monolayer enriched in glycerolipids, sterols, and signaling molecules. EVs can be used fresh, concentrated, or lyophilized prior to combination with the scaffold.

In some aspects, the scaffold provides a physical framework for immobilizing differentiated cells and/or EVs. Suitable materials include hydrogels, polysaccharides (e.g., cellulose, pectin, alginate), or synthetic biopolymers (e.g., PEG, PLA, PHA). The scaffold may be formed as a film, gel, coating, or porous structure allowing gas and fluid exchange. In certain embodiments, the scaffold is designed to emulate vascular tissue architecture, enabling directional transport of fluids and metabolites.

In some aspects, differentiated vascular cells are incorporated into the scaffold during or after polymerization. EVs may be mixed with the matrix material or immobilized via adsorption, covalent coupling, or encapsulation. The resulting composite exhibits structural integrity and bioactivity, facilitating regeneration of plant tissue, wood, or analogous materials upon contact with damaged surfaces or substrates. The differentiated cells serve as the structural and metabolic framework of the biomaterial, while the EVs act as nano-messengers transmitting signals that trigger gene expression, enzymatic repair, and matrix remodeling in adjacent tissues. Together, these components form a self-contained regenerative system capable of restoring function and structure.

The various embodiments in any of the aspects disclosed herein are combinable (e.g., within an aspect), as appropriate. Individual features (e.g., embodiments) disclosed herein are combinable in any manner desired, as applicable.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

It should be appreciated that any patent, publication, or other disclosure material, in whole or in part, which is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

### BRIEF DESCRIPTION OF DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 schematically illustrates various formulations;

FIG. 2 schematically illustrates a section of wood stem;

FIG. 3 schematically illustrates plant stem cell differentiation;

FIG. 4 schematically illustrates synthetic plant cell constructs;

FIG. 5 schematically illustrates 3D printing configurations of synthetic plant cell constructs;

FIG. 6 schematically illustrates hydrations synthetic plant cell constructs;

FIG. 7 is a flowchart of a method disclosed herein;

FIG. 8 is a flowchart of a method disclosed herein;

FIG. 9 is a flowchart of a method disclosed herein;

FIG. 10 schematically illustrates mending of a wooden piece;

FIG. 11 is a flowchart of a method disclosed herein;

FIG. 12 schematically shows a control system; and

FIG. 13 schematically shows a processing system.

The figures and components therein may not be drawn to scale. Various components of the figures described herein may not be drawn to scale.

### DETAILED DESCRIPTION

While various embodiments of the inventions have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Terms such as “a,” “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y” including in the specification and claims is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following, as applicable: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

When ranges are specified for an attribute, it is meant herein that the attribute may include the value specified at the end of the range. For example, when the attribute is of a value of at least about X, the attribute can be X, or any value greater than X. For example, when the attribute is of a value of at most about Y, the attribute can be Y, or any value smaller than Y. For example, when the attribute is of a value from V to Z, the attribute can be V, the attribute can be Z, or the attribute can be any value between V and Z.

The term “operatively coupled,” “operatively configured,” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

In some embodiments, a formulation is generated to be utilized in product comprising plant cells. The formulation can be utilized to generate, or to supplement, a plant tissue. The plant cell tissue may be synthetic or natural. The formulation can be utilized to mend existing plant tissue, e.g., existing as a living plant tissue, or a dead plant tissue. The plant tissue may be of (a) a natural plant, (b) a genetically engineered plant, (c) a grafted plant, (d) a plant created by somatic hybridization, (e) a plant created by somaclonar variation, (f) a plant created by embryo rescue, or (g) a synthetic object comprising a plant cell such as disclosed herein. The formulation can be utilized to generate a synthetic plant tissue. The formulation may comprise pluripotent plant cell type(s), differentiated plant cell type(s), Exomix type(s) defined herein, or Exomix form(s). The plant cell may be of any plant comprising wood, or any other plant such as disclosed herein. The differentiated plant cells may comprise transitory indeterminate cells or determinate cells. The Exomix may or may not be encapsulated. The formulation may comprise at least two different pluripotent plant cell types. The formulation may comprise at least one pluripotent plant cell type and one differentiated plant cell type. The formulation may comprise at least two different differentiated plant cell types. The formulation may comprise at least two different Exomix types. The different Exomix types may differ in at least one component of the Exomix mixture, e.g., as disclosed herein. The formulation may comprise at least two different forms of Exomix, e.g., as disclosed herein. The different Exomix form may differ in the manner of their encapsulation, including lack of encapsulation. The formulation may comprise one pluripotent plant cell type. The formulation may comprise one differentiated plant cell type. The formulation may comprise one Exomix type. The formulation may comprise one Exomix form.

In some embodiments, the formulation comprises an “Exomix.” The Exomix may be derived from plant cells such as from pluripotent plant cells and/or from differentiated plant cells. The Exomix may comprise an interior of the EVs, or a mixture similar to an interior of the EVs. The Exomix can be natural or synthetic. The Exomix may (e.g., additionally) comprise material unavailable in natural EVs. A synthetic Exomix can include additional substances absent in the natural Exomix, e.g., to enhance and/or direct one or more cellular properties. The one or more cellular properties may comprise (a) a cell regeneration path, (b) a cell differentiation path, (c) enhanced naturally occurring cellular properties, (d) artificial cellular properties, or (e) any combination thereof. A cell may be genetically engineered to generate EVs with a prescribed Exomix, e.g., that is unnatural not found in nature. Plant EVs may be of type(s) comprising an exosome, a microvesicle, an apoptotic body, an apoplastic vesicle, or a plant-derived nanovesicle. The exosome is derived from multivesicular bodies. The plant EVs may be derived from a naturally occurring plant cell or from a genetically engineered plant cell. The multivesicular bodies may be involved in intercellular communication. The microvesicles may bud from the plasma membrane. The microvesicles may participate in various physiological processes. The apoptotic bodies are generated during programmed cell death. The apoptotic bodies may contain cellular debris and/or other biomolecules. The apoplastic vesicles are located in the apoplast. The apoplastic vesicles may be involved in plant defense, immunization, and/or signaling. The plant derived nanovesicles may have drug delivery capabilities. The plant derived nanovesicles (e.g., content thereof) may have mammalian therapeutic potential. The Exomix may comprise content of one or more of the natural EV types. An Exomix type may relate to a natural EV content type. An Exomix type may comprise a combination of natural EV content types. The Exomix may comprise non-natural compounds, or natural compounds at a non-natural concentration. The non-natural concentration may be a lower concentration or a higher concentration. The non-natural concentration may be relative to the concentration of the compound in a natural EV. A library of Exomix formulations can be created. The Exomix may be utilized to differentiate the pluripotent cells, e.g., along selected differentiation path(s). The plant stem cells may be differentiated to generate a plant cell library. The cell library may comprise a pluripotent cell library comprising pluripotent cell types. The Exomix may comprise nutrients for the plant cells in the target. The target may comprise a natural plant cell tissue, or a synthetic plant cell tissue. The target may be biodegradable. In an example, the Exomix may comprises protein(s), lipid(s), or nucleic acid(s). The protein(s) may comprise adhesion molecules, cytoskeletal proteins, or enzymes. The proteins may comprise tetraspanins. The lipids may comprise phospholipids. The lipids may comprise cholesterol, ceramides, or sphingomyelin. The lipids may be part of, or designated to be part of, a membrane structure. The membrane structure may be of a cell in the target. The membrane structure may be part of the EV encapsulation. The lipids may be part of, or designated to be part of, the encapsulation of the Exomix. The nucleic acid may comprise genetic material. The genetic material may comprise RNA or DNA. The RNA may include any type of RNA, e.g., comprising rRNA, mRNA, tRNA, or miRNA. In an example, the Exomix comprises mRNA or miRNA. The formulation may comprise pluripotent cell type(s), differentiated plant cell type(s), or Exomix type(s). The formulation may comprise plant cells in different differentiation stages of a certain differentiation path, e.g., to imitate the cellular composition in a living tissue. The formulation may comprise cells in one or more differentiation paths. The different differentiated cell types can differ from each other (a) by the stage of their development, (b) by the pluripotent cell type from which they differentiated from, (c) by the differentiation paths from the same pluripotent cell type, or (d) any applicable combination thereof. The plant cell may be of any plant such as disclosed herein. The Exomix type in the formulation can be encapsulated and/or non-encapsulated. The encapsulation of the Exomix may be in a naturally occurring EV. Exomix may be encapsulated in an artificially made vesicle such as containing phospholipids. The phospholipids can be arranged in a monolayer. The phospholipids can be arranged in a multilayer arrangement such as a bilayer, e.g., similar to a naturally occurring phospholipid bilayer. The encapsulation of the Exomix may comprise channel(s) such as protein channels. The encapsulation may comprise at least one binding site comprising protein binding site, target ligand, or conjugated ligand. The encapsulation may comprise Stoma. An Exomix type of the formulation can be encapsulated by one or more encapsulation types. A form of the Exomix in the formulation may comprise encapsulated Exomix, or non-encapsulated Exomix. The form of the Exomix in the formulation may comprise naturally encapsulated Exomix, artificially encapsulated Exomix, or non-encapsulated Exomix. At least two forms of the Exomix in the formulation can include the same Exomix type. At least two forms of the Exomix in the formulation can include different Exomix types. In an example, a formulation can include a first Exomix type that is non-encapsulated. In an example, a formulation can include a first Exomix type that is non-encapsulated and a second Exomix type that is encapsulated. In an example, a formulation can include a third Exomix type that is non-encapsulated, a fourth Exomix type that is naturally encapsulated, and a fifth Exomix type that is synthetically encapsulated. At least two of the third Exomix type, the fourth Exomix type, and the fifth Exomix type may be (e.g., substantially) the same. At least two of the third Exomix type, the fourth Exomix type, and the fifth Exomix type may be different. In an example, a formulation can include a sixth Exomix type having a first encapsulation type, and a seventh Exomix type having a second encapsulation type. The sixth Exomix type can be (e.g., substantially) the same as, or different from, the seventh Exomix type. The first Exomix encapsulation type can be (e.g., substantially) the same as, or different from, the second Exomix encapsulation type. The first Exomix encapsulation type can be natural or synthetic. The second Exomix encapsulation type can be natural or synthetic. In an example, the Exomix encapsulation types are (e.g., derived from) two different naturally occurring EVs. In an example, the encapsulated Exomix is (e.g., derived from) a naturally occurring EV such as an exosome. The one or more types of differentiated plant cells in the formulation may comprise plant cells in one or more stages of cell differentiation. The pluripotent plant cell of the one or more types may be derived from a pluripotent plant cell library. The pluripotent plant cell library may comprise a plant stem cell. The one or more types of differentiated plant cells may be derived from a plant cell library. The at least one Exomix type may be derived from the Exomix library. The Exomix may or may not be encapsulated as EVs. The EVs in the formulation may be of one or more types. The EVs may be derived from an EV library. In some embodiments, Exomix in the formulation is unencapsulated. The formulation may comprise differentiated cells. The formulation may comprise pluripotent plant cells or be devoid of pluripotent plant cells. The formulation may comprise differentiated plant cells or be devoid of differentiated plant cells. The formulation may or may not comprise EVs. The Exomix may play a role in stress response, defense, intercellular communication, or any combination thereof. The Exomix (e.g., as EVs) can be released and/or in-taken by the cells, e.g., using receptors in the plant cell wall. The EVs can be released and/or in-taken by the cells, e.g., using receptors in the plant cell wall. EVs can be generated and/or exchanged using multivesicular bodies (MVBs). The Exomix can be in any form disclosed herein. For example, the Exomix in a formulation can be encapsulated as natural EV and/or in a synthetic EV. The Exomix may comprise nucleotides (as DNA and/or RNA), lipids, proteins, minerals, other cell metabolites, or alteration agents such as enzymes or transcription factors. The Exomix may be released by the pluripotent cells (e.g., as encapsulated in exosomes). The pluripotent cell Exomix can be used without the pluripotent cells, e.g., to create and/or to regenerate a plant cell tissue. The Exomix (e.g., as encapsulated in EVs) can influence plant cell wall, cell development, disease resistance, pathogenic delivery, pathogenic resistance, or any other of the at least one function of living plant cells such as disclosed herein. The Exomix and/or EVs, may influence communication comprising intercellular communication or intracellular communication. The Exomix can aid in formation of the connective tissue holding the cells together as a tissue. The Exomix can become part of the extracellular matrix. A cell may be genetically engineered to generate EVs with a certain Exomix, e.g., that is unnatural. The Exomix may be derived from natural sources or synthetic sources. The synthetic sources may comprise natural cells that have been genetically engineered. The natural sources may be derived from the library of plant cells, e.g., as disclosed herein. The Exomix may include artificial compounds, e.g., may be partially or entirely artificially fabricated. The Exomix may comprise materials other than (e.g., in addition to) one or more hormone classes, e.g., different from the hormone classes auxin and cytokinin. For example, the Exomix may comprise genetic material (e.g., RNA/DNA), enzymes, signal peptides, transcription factors, or phospholipids. For example, some members of the NAC transcription factor (NAC TF) family and EXPAMSIN protein family. A library of Exomix may be created and a (e.g., respective) library of exosomes. The methods disclosed herein may utilize Exomix in a non-encapsulated form, in the form of synthetic encapsulation, or in the form of natural encapsulation. The synthetic plant cell-based product may comprise Exomix, e.g., encapsulated as EVs. The Exomix may derive from a plant biowaste such as an organic byproduct. The organic byproduct may comprise pulp, e.g., that would otherwise be discarded. Any of the plant cells may derive from a plant biowaste such as an organic byproduct. The organic byproduct may comprise pulp, e.g., that would otherwise be discarded. The preparation methods may be controlled, e.g., using any control system disclosed herein. At least one controller of the control system is operatively coupled, whether directly or indirectly, to effectuate the preparation function(s). The preparation methods may comprise preparing the formulation, the EVs, or any of the libraries disclosed herein.

In some embodiments, the present disclosure leverages molecular programs that govern regeneration of vascular and dermal plant tissues. Following wounding or structural degradation, living parenchyma cells adjacent to a damaged xylem or phloem region undergo dedifferentiation and re-entry into the cell cycle. This process is transcriptionally and hormonally controlled by a defined network of regulators that may be emulated, induced, or supplemented through Exomix signaling formulations.

In some embodiments, the wound-responsive transcription factors including members of the AP2/ERF family (WIND1-4, ERF115) and NAC family (ANAC071, ANAC096, ANAC011) activate cellular reprogramming and cytokinin-responsive proliferation. In certain embodiments, the Exomix formulation comprises vesicular cargo comprising nucleic acids or proteins capable of inducing expression of these or functional analogs thereof. Early regenerative signaling is further mediated by auxin, cytokinin, jasmonic acid, and ethylene, which jointly establish polarity and competence for regeneration. The Exomix may therefore include plant-derived vesicles enriched in auxin-transport lipids, cytokinin precursors, or jasmonate-responsive peptides that amplify local wound-induced responses.

In some embodiments, the reactivation of the vascular cambium and initiation of secondary growth are coordinated by the WOX4/WOX14, HD-ZIP III (REV, PHB, PHV, ATHB8), and KNOX class I (KNAT1/BP, STM) transcription factor families, which maintain meristematic identity and regulate the balance of auxin and cytokinin signaling across cambial layers. The Exomix may comprise extracellular vesicles containing mRNAs or small RNAs homologous to WOX4, REV, or KNAT1, or other agents that up-regulate cambial proliferation and patterning.

In certain embodiments, the formulation additionally includes lipid or sterol cofactors known to enhance auxin transport and brassinosteroid signaling, thereby promoting xylem differentiation.

In some embodiments, formation of lignified xylem elements is governed by a hierarchical transcriptional cascade beginning with NAC-domain master regulators (VND6, VND7, SND1, NST1), followed by downstream MYB-type transcription factors (MYB46, MYB83, MYB58, MYB63, MYB85) that activate structural genes encoding enzymes of the cellulose, hemicellulose, and lignin biosynthetic pathways. In some embodiments, Exomix vesicles comprise peptides, RNAs, or cofactors that up-regulate this pathway, resulting in accelerated lignification, secondary-wall deposition, and enhanced mechanical integrity of regenerated wood tissue.

Phloem identity and bark repair are directed by APL (ALTERED PHLOEM DEVELOPMENT) and NAC45/86 transcription factors, which promote sieve-element differentiation and suppress xylem gene expression. Subsequent periderm regeneration involves MYB41, MYB107, MYB9, MYB93, NAC058, and SHN1/WIN1, which activate suberin and cuticular-wax biosynthetic genes (GPAT5, CYP86A1, FAR4/5). Exomix vesicles may therefore deliver mRNAs, microRNAs, or lipid precursors that stimulate periderm cell formation, suberization, and sealing of the wound interface.

In some embodiments, the above regulators constitute a regenerative signaling circuit that converts dedifferentiated cells into organized cambial derivatives, xylem, phloem, and periderm. In some embodiments, the Exomix library comprises a plurality of vesicle types, each containing cargo associated with one or more of these transcriptional or hormonal regulators, enabling staged or spatially targeted activation of regenerative pathways. Delivery of such Exomix vesicles to a synthetic or natural wood substrate can accelerate repair, enhance lignification, and restore functional continuity of vascular tissues.

In some embodiments, Exomix is encapsulated to generate EVs. EVs may be further encapsulated, e.g., have at least a secondary, tertiary, quaternary, or higher degree of encapsulation. A first encapsulated EV type and a second encapsulated EV type may be encapsulated together in a grouping encapsulation. The first encapsulated EV type and a second encapsulated EV type may be (e.g., substantially) the same. The first encapsulated EV type and a second encapsulated EV type may be different in at least one EV component. The at least one EV component may comprise an Exomix type, or an encapsulation type.

In some embodiments, Exomix is encapsulated as EVs. The EVs may have a border or a membrane. The membrane may be similar to a naturally occurring EV membrane. The membrane may comprise lipids, channel(s), ligand(s), or receptor(s). The lipids may be arranged in any arrangement creating a membrane such as disclosed herein, e.g., as a lipid bilayer. The encapsulation of the Exomix as an EV may facilitate directing the EV to a specific area of the target, a specific cell in the target, and/or a specific location of the target. The encapsulation of the Exomix may at least in part control release of one or more components of the Exomix outside of its encapsulation. The encapsulation of the Exomix may time the release of the Exomix, e.g., may slow the release of the Exomix from its encapsulation. The EVs can aid in generation of a connective tissue holding the cells together as a tissue, e.g., by providing precursor type(s) to the connective tissue such as an extracellular matrix. The Exomix (e.g., the EVs) can become part of and/or be embedded in, the extracellular matrix. The Exomix and/or EVs in the formulation may direct a prescribed differentiation pathway of the plant stem cells. The formulation may be utilized for the target and/or for differentiating the pluripotent cells. The formulation may be utilized to generate a plant cell library, e.g., as disclosed herein. The EVs may be at least 4, 3, or 2 orders of magnitude smaller than the plant cells. The EVs may have a nanometer scale FLS, while plant cells may have a micrometer scale fundamental length scale (FLS). The EV may be (e.g., similar to) a natural plant EV. A FLS (e.g., diameter) of the EV may be at least about 20 nanometers (nm), 30 nm, 50 nm, 80 nm, or 100 nm. A FLS (e.g., diameter) of the EV may be at most about 1000 nm, 500 nm, 200 nm, 160 nm, 150 nm, 100 nm, 80 nm, or 50 nm. A FLS (e.g., diameter) of the EV may be of a value between any of the aforementioned values, e.g., from about 20 nm to about 200 nm, or from about 30 nm to about 160 nm. A FLS (e.g., diameter) of the plant cells may be at least about 5 micrometer (μm), 10 μm, 20 μm, 30 μm, 50 μm, 80 μm, or 100 μm. A FLS (e.g., diameter) of the plant cell may be at most about 150 μm, 100 μm, 80 μm, or 50 μm. A FLS (e.g., diameter) of the plant cell may be of a value between any of the aforementioned values, e.g., from about 10 μm to about 150 μm, or from about 10 μm to about 100 μm.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter equivalent of a bounding sphere, a radius, a spherical equivalent radius, or a radius of a bounding circle, or a radius of a bounding sphere.

In some embodiments, a synthetic plant tissue is generated, e.g., via tissue engineering. The synthetic plant tissue may comprise a synthetic wood tissue. Fabrication of the synthetic plant tissue may comprise, and/or may be aided by using, the formulation, e.g., as disclosed herein. Fabrication of the synthetic plant tissue may utilize plant cells of one or more types, e.g., as disclosed herein. Fabrication of the synthetic plant tissue may comprise (i) plant cell type(s) from the plant cell library, or (ii) Exomix from the Exomix library.

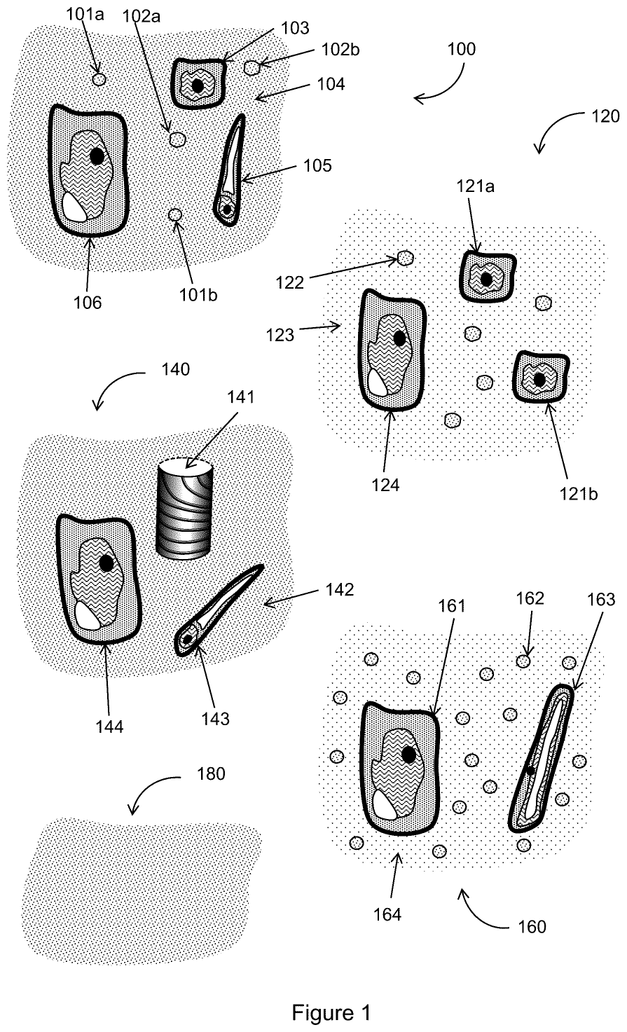

FIG. 1 shows example of various formulations. In example 100, Exomix 104 in nonencapsulated form comprises pluripotent cell 103, and two different types of differentiated plant cells 105 and 106. Natural EVs 102a and 102b are included in the formulation of example 100, as well as synthetic EVs 101a and 101b. In example 120, medium 123 is different from an Exomix, and can be a solution and/or a supportive structure such as disclosed herein. Medium 123 comprises pluripotent cell 121a and 121b, one type of differentiated cell 124, and natural EVs such as 122. Example 140 shows Exomix 142 is non encapsulated form comprising different plant cell types 141, 143 and 144. Example 160 shows medium 164 that can be different from Exomix such as a supportive structure and/or a solution. Medium 164 includes synthetic EVs such as 162, and two different cell types 161 and 163. Example 180 shows a formulation that includes Exomix in non-encapsulated form. Other formulation examples now whose in FIG. 1 are available, e.g., as disclosed herein. For example, a formulation comprising natural EVs and/or synthetic EVs, in a non-encapsulated Exomix or in another medium such as medium 123.

In some embodiments, the plant cells are utilized herein. The plant cells comprise cell walls. The cell walls may comprise a primary wall, a secondary wall, or an intermediate wall (middle lamella). The plant cells may comprise wood cells. The wood cells may be harvested from any wood tissue. The wood tissue may mimic at least in part any of the wood tissues. The wood tissues may comprise bark, phloem, cambium, or xylem. A synthetic tissue can be synthetized, comprising the plant cells. The plant cells may comprise wood cells. The wood cells may be harvested from any wood tissue. The wood tissue may mimic at least in part any of the wood tissues. The wood tissues may comprise bark, phloem, cambium, or xylem.

In some embodiments, disclosed herein is a manufacture comprising a synthetic plant tissue that includes plant cells. The synthetic plant tissue can be a living plant cell tissue. The living cell tissue may have one or more cell types that retain at least one function of living plant cells. The at least one function of living plant cell may comprise respiration, assimilation, photosynthesis, expulsion of materials from the cell (exocytosis), intake of materials into the cell (endocytosis), maintenance of cell morphology, nutrient storage in the cell, waste production in the cell, maintaining turgor pressure of the cell, cell growth, cell division, cell immunity, senescence, cell death, intracellular communication, intercellular communication, energy conversion, morphology, or genetic expression. Maintenance of cell morphology may comprise maintenance of structural support of the cell such as integrity of cell wall(s). The plant tissue may comprise one or more plant cell types. The one or more plant cell types may comprise wood cell types. The plant tissue may comprise a wood tissue such as a living wood tissue. The plants comprising the wood tissue may be woody plants including various natural genetic variations and characteristics. The woody plants may comprise trees and shrubs. The woody plant cells may have a potential for a higher rate of growth and/or cell division as compared to non-woody shrubs. The woody plants comprising the wood tissue may comprise a higher level of lignin as compared to non-woody plants. The woody plants may comprise a percentage of lignin of at least about 10%, 15%, 20%, 25%, 30%, 35%, 40%, 45%, or 50%, the percentage being a weight per weight percentage of dry mass. The woody plants may comprise a percentage of lignin between the aforementioned percentages, e.g., from about 10% to about 50%, or from about 15% to about 40%, the percentage being a weight per weight percentage of dry mass. The woody plant may be utilized as softwood. The woody plant may be utilized for packaging and/or paper products. The wood may comprise pine, spruce, fir, birch such as silver birch, larch, hemlock, or eucalyptus. The synthetic wood tissue may comprise long cellulose fibers. The woody plant may be utilized for timber production. The woody plant may be utilized as hardwood. The hardwood may comprise oak, sycamore, cherry, beech, or birch. The woody plant may comprise fir such as Balsam fir, pine such as eastern white pine, or spruce such as Norway spruce. The woody plant may comprise conifer. The conifers may comprise Sitka, spruce, pine such as Scots, pine, fir such as Douglas fir, or larch. The woody plant may comprise palm such as date palm. The plant cell may relate to plants utilized commercially for non-edible use. The plant cell may comprise cotton, zinnia, marigold, hemp, Jute, bamboo, flax, or rubber tree.

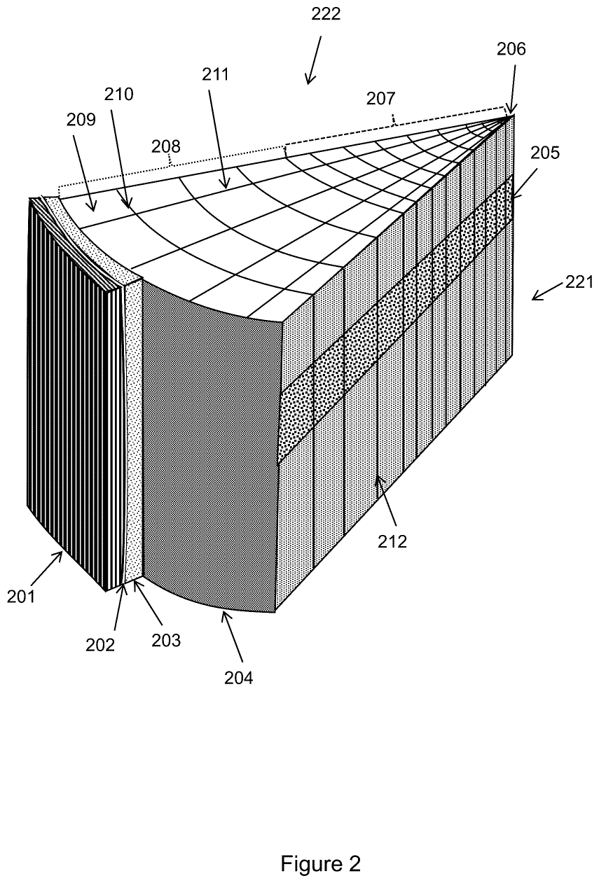

FIG. 2 shows an example of a wood trunk slice including various plant tissues that are wooden tissues. Bark 201 has an outer bark surface facing the ambient environment in which the trunk portion is disposed, and an opposing inner bark section facing the interior of the tree trunk portion towards pith (Medulla) 206. Epidermis 201 of the cork tissue contacts cork cambium 202 that contacts phloem 203 including primary and secondary phloem portions. The secondary phloem section contacts vascular cambium 204. The surface of vascular cambium 204 facing pith 206 contacts the xylem including secondary xylem 208 that contacts primary xylem 207. The phloem 203 is located between cork cambium 202 and vascular cambium 204. Thus, the tree trunk includes two separate layers of cambium cells comprising vascular cambium 204 and cork cambium 202. Cell division within the vascular cambium can give rise to the xylem and to the secondary phloem. The phloem is located in the inner portion of the tree bark. Cell division within the cork cambium can give rise to the periderm (of the outer bark) that includes epidermis 201. The vascular cambium and the cork cambium together comprise the lateral meristem. Wood rays (a.k.a., Medullary rays) are schematically depicted as 205 in the radial surface 221, and 211 in the transverse surface 222. The wood rays can comprise parenchyma cells. The wood rays serve living functions comprising horizontal transport of nutrients and water, or storage of food. The wood comprises annual rings such as ring 210 depicted in transverse surface 222, and ring 212 depicted in the radial surface 221. The annual rings separate xylem portions such as 209. The wood interior comprises sapwood of secondary xylem 208, hardwood of primary xylem 207, and pith 206 disposed at the center of the tree trunk.

In some embodiments, disclosed herein is a manufacture of a synthetic plant tissue. As compared to a respective natural plant tissue used commercially, the synthetic plant tissue manufactured with the methods disclosed herein, can be configured to self-maintain, e.g., configured to maintain its strength over time. Self-maintain may comprise maintaining at least one function of living plant cells such as disclosed herein. As compared to a respective natural plant tissue used commercially, the synthetic plant tissue can be configured to (a) better maintain cell immunity, (b) slow senescence, (c) postpone cell death, or (d) any combination of (a), (b), and (c). Maintaining cell immunity may comprise reducing, or be resistant to, intrusion of foreign species. The foreign species may comprise virus, bacteria, or fungi. As compared to a respective natural plant tissue used commercially, the synthetic plant tissue can be configured to better maintain any special living plant property, e.g., fire resistance. The special plant properties may comprise unique properties of select plant type(s). The synthetic plant tissue may be designed to impede forces reducing its longevity. The forces reducing the longevity may comprise invasion, attack, or invasion and attack, by the foreign species and/or by environmental factors. The synthetic plant tissue can be synthesized with one or more plant tissue properties that (a) are non-natural, enhancement of natural wood properties, (b) maintain plant properties of the natural plant, (c) enhance plant properties of the natural plant, or (d) any combination thereof. The plant can comprise wood or any other plant such as disclosed herein. The one or more plant tissue properties may be associated with any plant tissue disclosed herein. The one or more plant tissue properties of the synthetic plant tissue may comprise photosynthesis, storage, support, transport of water, transport of nutrients through the tissue, control gas exchange, reduce water loss, provide immunity, slow senescence, postpone cell death tissue growth, or cell morphology such as structural support of the tissue. The one or more plant tissue properties may comprise electrical, thermal, visual (aesthetic), tactile, olfactory, acoustical, strength, durability, malleability, stiffness, or resistance to fire. The electrical property may comprise generation of electric charge. The electric charge may be generated as a response to applied mechanical stress. The electrical charge may derive from a piezoelectric effect. The synthetic cell plant tissue may have a Young's modulus range similar to a natural plant tissue, e.g., from about 6 Giga Pascals (GPa) to about 60 GPa. The synthetic cell plant tissue may have a Young's modulus range greater than respective natural plant tissue at least about 6 GPa, 10 GPa, 20 GPa, 25 GPa, 30 GPa, 40 GPa, 50 GPa, or 60 GPa. The Young's modulus may be similar to that of a (e.g., soft) metal, e.g., comprising gold, silver, aluminum, lead, cadmium, zinc, cadmium, or copper. The synthetic cell plant tissue may have a Young's modulus range lower than the respective natural plant tissue at most about 5 GPa, 10 GPa, or 20 GPa. The synthetic cell plant tissue may have a Young's modulus range between any of the aforementioned values. The one or more artificial properties of the plant cell tissue may be obtained at least in part through genetic modification of a plant cell type in the plant tissue. For example, the piezoelectric property of the plant cell tissue may be obtained through genetic modification that would alter composition of the cell wall(s). In some embodiments, the synthetic plant tissue is utilized for tissue regeneration and/or mending. The synthetic plant tissue may be generated using pluripotent cells, differentiated plant cells, and/or the Exomix. The synthetic plant tissue may be generated using the formulation, e.g., as disclosed herein.

In some embodiments, plant pluripotent cells are more accessible as compared to respective mammalian pluripotent cells. The pluripotent cells may comprise stem cells. Plant cells may regenerate de novo and maintain pluripotency, e.g., allowing the production of new tissues (e.g., and organs) over their lifetime. Plant cells may exhibit higher chromatin accessibility. The higher chromatic accessibility may facilitate transcription factor binding and/or developmental flexibility. Some plant cell types may have a way to regain their pluripotent capacity such as re-differentiating, e.g., back differentiate into the different differentiation stages, which mechanism unavailable in mammalian stem cells. Harvesting plant stem cells may involve fewer ethical considerations as compared to mammalian (e.g., human) stem cells.

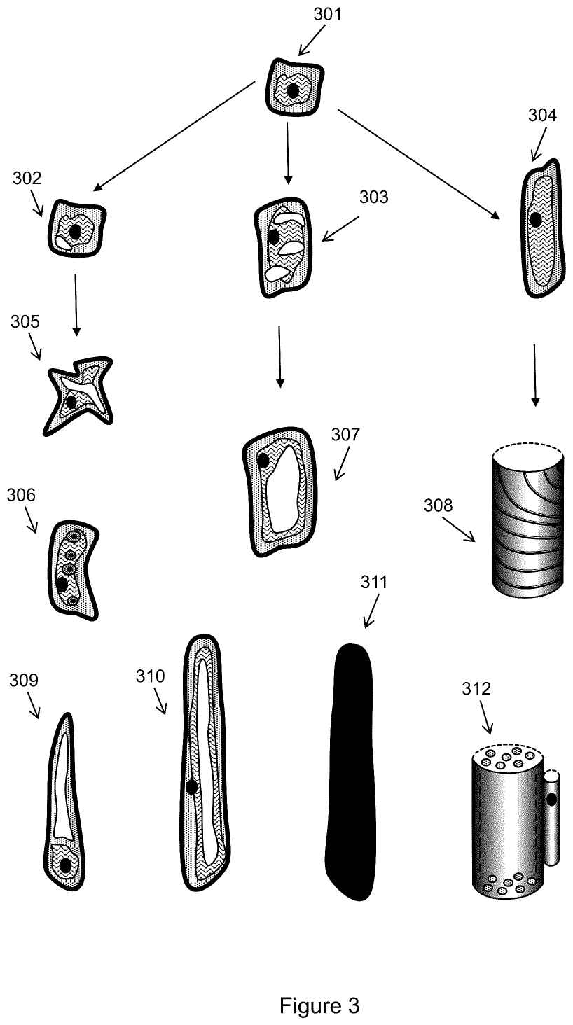

FIG. 3 shows an example of plant cell differentiation. Apical meristem cell 301 differentiates into protoderm cell 302, ground meristem cell 303, and procambium cell 304. Protoderm cell 302 can differentiate into various types of epidermis cells comprising pavement cell 305, guard cell 306, or trichome cell 309. Ground meristem cell 303 can differentiate into parenchyma cell 307. Parenchyma cell 307 can differentiate into various cell types comprising collencyma cell 310 or into scirenchyma cell 311. Procambium cell 304 can differentiate into various cell types comprising vessel element 308 (e.g., helical type), or sieve type element 312 (e.g., having a companion cell).

In some embodiments, a synthetic plant tissue is generated, e.g., manufactured. The synthetic plant tissue comprises plant cell type(s). The plant cells may relate to a naturally occurring plant tissue. The plant stem cells may be derived from meristematic tissues, which are responsible for growth and development. The plant stem cells may comprise apical meristem stem cells, lateral meristem stem cells, or procambium cells. The apical meristem stem cells are found in the shoot and root of the plant. The lateral meristem stem cells are found in vascular cambium and cork cambium and contribute to secondary growth. The procambium cells differentiate to various stem cell types in the vascular system, the various stem cell types comprising primary xylem (e.g., protoxylem) or primary phloem. The primary phloem may comprise phloem parenchyma cells, sieve elements, companion cells, or phloem fibers. The plant stem cells may follow at least one maturation path. The synthetic plant tissue may supplement, or mimic, a natural plant cell. The natural plant cell may comprise the Cambium tissue. The synthetic Cambium tissue may comprise cells developing into bark, sap cells, interior hardwood cells, or cells responding to wound in trees. The synthetic Cambium may comprise vascular cambium and cork cambium. The synthetic vascular cambium may include tracheid element a type of stem cell. The tracheid element may differentiate into the secondary Xylem or into secondary phloem. Due to its ability to differentiate to one of two cell types, the tracheid element has stem cell properties. The secondary phloem may facilitate (a) water conduction and/or (b) maintenance of cell morphology such as structural support for the plant tissue in which it resides. The synthetic cork cambium tissue (a.k.a. phellogen) may produce cork cells. The cork cells may facilitate secondary growth, e.g., that chiefly increases thickness of the cells rather than their length. The apical meristem matures into three primary meristems comprising procambium, ground meristem, or protoderm. Meristematic cells can mature into parenchyma cells. The parenchyma cells may be further differentiated into collenchyma, sclerenchyma, or vascular cells. Because of their ability to differentiate into various cell types, the parenchyma cells may be considered stem cells. The parenchyma cells can be found in the vascular cambium and cork cambium. The synthetic ground meristem may develop into ground tissue. The ground meristem cells may differentiate into ground tissue cells comprising parenchyma, which can further differentiate to collenchyma or sclerenchyma cells. The ground meristem cells may (e.g., eventually) differentiate into cortex cells, or endodermal cells. The synthetic endodermal cells may aid in the development of the Casparian strip comprising lignin, e.g., which characterizes wood. The procambium may give rise to one or more vascular tissues. The procambium stem cells may differentiate into specialized xylem cell (e.g., primary xylem) comprising vessel element, or sieve tube element. The protoderm may develop into the epidermis. Protoderm cells may mature to epidermis cells comprising pavement, guard, or trichome cells.

In some embodiments, the plant pluripotent cell may undergo manipulation(s).

Parenchyma cells may be extracted from the secondary cambium. Parenchyma cells can differentiate to other cell types, e.g., as disclosed herein. The differentiated cell type(s) can exhibit fire resistance substance(s). The synthetic (e.g., artificial) plant tissue may be designed to maintain the cell culture having cells at various states of differentiation and development. The plant may comprise wood. The different cell stages may facilitate slow release of the property over a prolonged time, e.g., by including parenchyma cells and/or their differentiated cells. Slow-release methodologies may comprise encapsulation of Exomix that facilitate slow release of the Exomix through the encapsulation, e.g., as disclosed herein. The encapsulation may comprise gelatin, cellulose, or a lipid such as disclosed herein. The lipid may be arranged in a phospholipid bilayer. Release of Exomix containing vesicles (whether synthetic or natural) may be controlled at least in part by (a) embedding the vesicles in a supportive structure, (b) aggregating the Exomix containing EVs in a grouping encapsulation such as disclosed herein, or (c) a combination of (a) and (b). The supportive structure may comprise a matrix or a scaffold. The supportive structure may be natural or synthetic. The supportive structure can comprise organic, inorganic, or silicon-based compounds. The supportive structure may be solid or semisolid (e.g., gel). The supportive structure may comprise a foam, or a sheet such as a planar sheet. The supportive structure may comprise a network structure. The network structure may comprise large molecules. The large molecules may comprise a polymer or a resin. The supportive structure comprise (e.g., can be in a form of) a planar surface, a corrugated surface, or a sponge. The supportive structure may comprise one or more cavities. The cavities may be configured to accommodate at least one EV. The Exomix can be part of, or embedded in, the supportive structure. The Exomix can be part of a synthetic extracellular matrix. The Exomix can be part of a natural extracellular matrix. The pace of Exomix release from an EV may be engineered, e.g., in the case of synthetic encapsulation. The EVs may be reversibly deposited in the supportive structure and released from the supportive structure. The supportive structure may at least in part control the rate of release of (a) the EV and/or (b) the Exomix encapsulated in the EV. The release may be into the extracellular space. The release may be of the Exomix from the EV in which it is encapsulated. The Exomix can adhere to the supportive structure without being encapsulated in an EV. The release may be of the Exomix from the supportive structure. The supportive structure may be derived from a plant biowaste such as an organic byproduct. The organic byproduct may comprise pulp, e.g., that would otherwise be discarded. The supportive structure may comprise the extracellular matrix.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter. For example, when an EV is reversibly deposited in the supportive structure, that EV can also be released from that supportive structure. For example, when an EV is reversibly released from the supportive structure, that EV can also be deposited in that supportive structure.

In some embodiments, a synthetic plant construct may be fabricated such as manufactured. The construct may comprise plant cells, e.g., arranged as a plant cell tissue. The plant cells may be from the library of plant cells. The construct may comprise differentiated cells. The construct may comprise one or more niches (e.g., patches), or one or more channels. The niche may function as a reservoir of Exomix and/or cells. The channel may be configured to deliver the Exomix to cells in the construct, e.g., which do not border the niche. The niche may comprise any formulation disclosed herein. At least two niches in the synthetic plant cell construct may have (e.g., substantially) the same formulation. At least two niches in the synthetic plant cell construct may have different formulations. At least two niches in the synthetic plant cell construct may have (e.g., substantially) the same FLS. At least two niches in the synthetic plant cell construct may have different FLSs. At least two niches in the synthetic plant cell construct may have (e.g., substantially) the function with relation to the construct. At least two niches in the synthetic plant cell construct may have different functions with relation to the construct. In an example, the nice is surrounded by plant cells from all its sides, e.g., except for at least one optional channel extending out of the niche. The Exomix may be apportioned such that when the nutrients and stem cells will be consumed/developed, no water will remain to support the living function of the cells. The situation in which no water will remain to support the living function of the cells can include a lack of water. The Exomix apportioned may be (a) in the niche(s), (b) in the formulation, (c) in the EVs, (d) in the supportive structure, (e) attached to the supportive structure, or (f) any appropriate combination thereof. The attachment of the Exomix to the supportive structure may be reversible. The attachment of the EV to the supportive structure may be reversible.

In some embodiments, the synthetic plant cell construct comprises channels. The channels may be microfluidic channels. The channels may be in a size that facilitates fluidic communication of Exomix and/or EVs. The channels may be in a size that facilitates fluidic communication of cells disposed in the niches. The niches may be disposed in a multi-basal pattern type arrangement, e.g., an arrangement originating from multiple basal meristems. The niches may be disposed at critical locations in the plant cell construct (e.g., manufactured product) such as locations prone to decay and/or damage. The channels may adopt a drainage pattern. The drainage pattern may comprise a dendritic (pinnate), a sub-dendritic, a rectangular, a trellis, a parallel, a centrifugal, a centripetal, a distributary, an annular, an angular, a deranged, a contoured, a barbed, or a radial pattern.

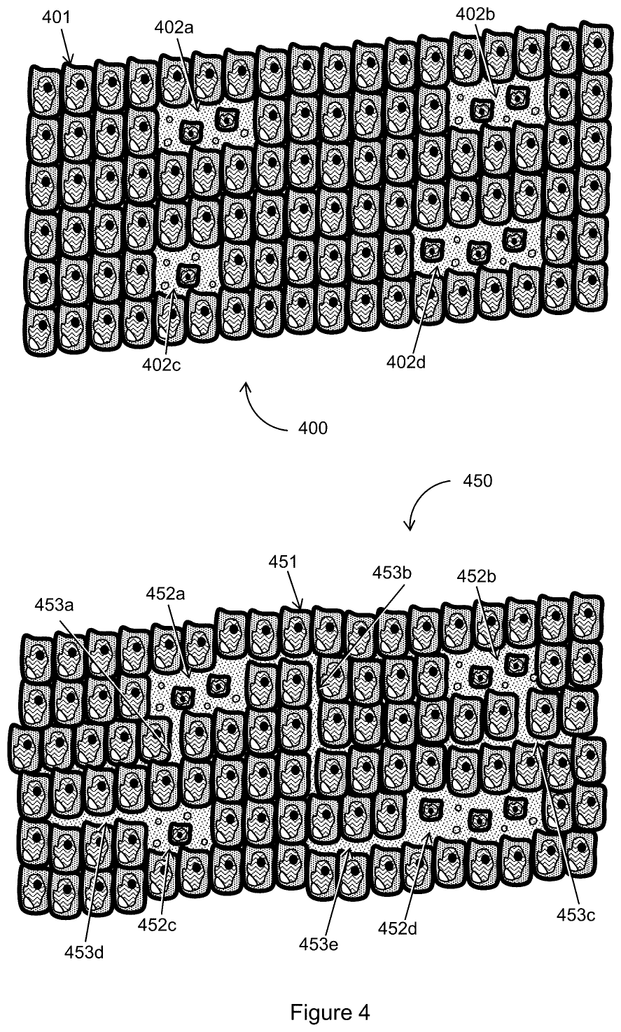

FIG. 4 shows examples of synthetic plant cell constructs. Example 400 shows a construct comprising differentiated cells such as 401. The construct in example 400 comprises niches such as 402a-d. Niches 402a and 402b are (e.g., substantially) similar to each other. Niches 402c and 402d are different from each other. The niches comprise EVs and plant cells of a different type from 401. The plant cells in the niches may compromise cells that may differentiate and/or mature into a cell type of 401. The plant cells in the niches may compromise cells that may differentiate and/or mature into a cell type different from 401. The plant cell in the niche may be any plant cell such as from the plant cell library. In an example, the plant cell in the niche is a differentiated cell. The construct in example 401 is devoid of channels. Example 450 shows a construct comprising differentiated cells such as 451. The construct in example 450 comprises niches such as 452a-d. Niches 452a and 452b are (e.g., substantially) similar to each other. The niche may comprise any of the formulations disclosed herein. Niches 452c and 452d are different from each other. The niches comprise EVs and plant cells of a different type from the differentiated cell 451. The construct in example 450 includes channels 453a-e, configured to allow fluidic communication (e.g., of Exomix) flowing from niches 452a-d, as appropriate.

In some embodiment, a synthetic plant product is fabricated such as manufactured, the plant product comprising a plant cell. The plant cell may be a wood cell, or any other plant cell such as disclosed herein. The plant product can be fabricated using at least one type of formulation disclosed herein. Fabrication of the plant product (e.g., construct) may comprise using a manufacturing process comprising additive manufacturing, subtractive manufacturing, molding, casting, forming, joining, or coating. Subtractive manufacturing may comprise milling or drilling. Forming may comprise forging or extruding. Joining may comprise using an adhesive such as a biological and/or biodegradable adhesive. The methodologies disclosed herein may reduce (e.g., eliminate) use of synthetic binder(s) such as synthetic binder that pose a health hazard to mammals such as humans. The binder may compromise glue. Coating may comprise using the formulation as paint over pre-formed products such as ones currently commercially available, naturally available, or newly fabricated product such as the construct disclosed herein. The additive manufacturing (also referred to herein as “three-dimensional printing”) may comprise bioprinting. The fabrication methodologies disclosed herein may be utilized to mend a damaged product such as comprising a plant cell. The damaged product may be a natural plant. The fabrication may be controlled, e.g., using any control system disclosed herein. At least one controller of the control system is operatively coupled, whether directly or indirectly, to effectuate the fabrication function(s). The synthetic plant product may be in a solution form. The solution may comprise the formulation. The solution may be utilized to harvest one or more plant product such as disclosed herein. The solution may be utilized to extract one or more materials from the environment such as carbon dioxide. The solution may be utilized to use one or more materials from the environment such as carbon dioxide, oxygen, water, smelly compound(s), or any combination thereof. The one or more materials may have at least one harmful property to a user, e.g., to the environment of the user. The smelly compound may have a repugnant smell. The smelly compound(s) may comprise sulfur, thiol, sulfide, isocyanide, or carboxylic acid. The smelly compound may comprise hydrogen sulfide, geosmin, butyric acid, n-butyl isocyanide, triethylamine, or cadaverine. The solution may be utilized to expel one or more materials to the environment such as oxygen and/or humidity. The one or more materials may have at least one beneficial property to a user, e.g., to the environment of the user. The one or more material may have a pleasant smell to an average user. The one or more material may comprise an ester, an alcohol, an aldehyde, or a ketone. The one or more material may comprise ethyl acetate, methyl butyrate, benzaldehyde, or diacetyl. The one or more material may comprise vanillin, linalool, geraniol, benzaldehyde, or ethyl maltol. The user may be a mammal such as a human. The one or more material may counteract repugnant smells. The one or more materials may comprise a volatile acid such as acetic acid. At the ambient environmental conditions in which the solution is disposed, the one or more materials may be volatile (e.g., gaseous), liquid, or form a slurry. The one or more material exchanged with the environment by the solution, may be exchanged with the ambient environment, e.g., as long as the solution is active such as alive. The one or more material exchanged with the environment by the solution, may be exchanged with the ambient environment, e.g., at least one living cell remains in the solution. In an example, the one or more material exchanged with the environment by the solution comprises expulsion, or intake, e.g., exocytosis or endocytosis.

In some embodiment, the formulation may be utilized for repairing a damaged product comprising a plant cell. The formulation may be any formulation disclosed herein. In an example, the formulation utilized for repair comprises Exomix, e.g., that is not encapsulated. The Exomix may be configured (e.g., prepared, and/or engineered) to maintain the at least one function of plant cells, e.g., comprising living plant cells or dead plant cells. In an example, the Exomix is configured (e.g., prepared, and/or engineered) to maintain the integrity of the plant cells, e.g., in a plant tissue. The repair may be controlled, e.g., using any control system disclosed herein. At least one controller of the control system is operatively coupled, whether directly or indirectly, to effectuate the repair function(s).

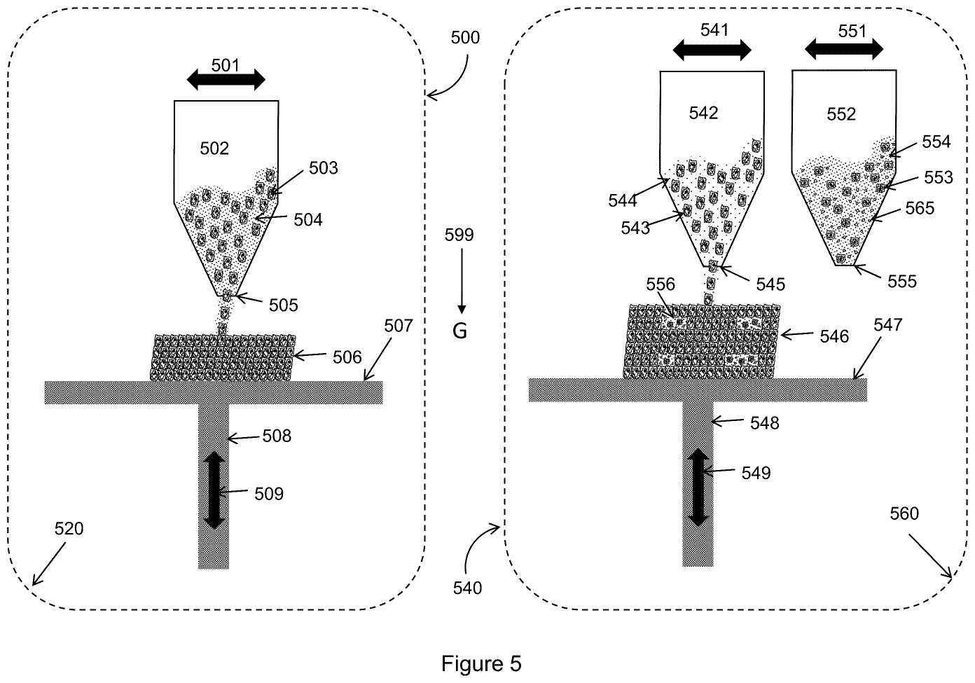

FIG. 5 shows examples of fabricating plant cell products by three-dimensional (3D) printing. Example 500 shows build platform 507 supported by shaft 508 that can stepwise vertically translate build platform 507 along arrow 509, e.g., using an actuator. Shaft 508 can be an elevator shaft. The stepwise vertical translation of build platform 507 is linked to the thickness of a layer of construct 506 supported by build platform 507. Recoater having interior space 502 contains a formulation comprising Exomix 504 in a non-encapsulated form and cells such as cell 503. The cells in interior space 502 are of a single cell type. The formulation exits recoater interior space 502 through opening 505 towards platform 507 at least in part using the gravitational force of an ambient environment in which the 3D printer is disposed. The gravitational force is directed towards the gravitational center G of the ambient environment, along vector 599. The 3D printer comprises an optional enclosure 520. The ambient environment is external to enclosure 520, if existing. Construct 506 is devoid of niches and comprises layer-wise deposition of the cells such as 503. At least during deposition of the formulation, the recoater can reversibly travel horizontally along direction 501.

Example 540 shows build platform 547 supported by shaft 548 that can stepwise vertically translate build platform 547 along arrow 549, e.g., using an actuator. Shaft 548 can be an elevator shaft. The stepwise vertical translation of build platform 547 is linked to the thickness of a layer of construct 546 supported by build platform 547. A first recoater having first interior space 542 contains a first formulation comprising first Exomix 544 in a non-encapsulated form and a first cell set such as cell 543. The first cell set in the first interior space 542 contain a single cell type. The first formulation exits recoater interior space 542 through opening 545 towards platform 547 at least in part using the gravitational force of an ambient environment in which the 3D printer is disposed. The gravitational force is directed towards the gravitational center G of the ambient environment, along vector 599. At least during deposition of the first formulation, the first recoater can reversibly travel horizontally along direction 541. The 3D printer comprises an optional enclosure 560. The ambient environment is external to enclosure 560, if existing. Construct 546 includes niches such as niche 556. Construct 546 and comprises layer-wise deposition of the cells such as 543. The niches are deposited using a second recoater having a second interior space 522. The second interior space 522 comprises a second Exomix type 554. A second recoater having second interior space 552 contains a second formulation comprising second Exomix 554 in a non-encapsulated form and a second cell set such as cell 553. The second cell set in the second interior space 552 contain a single cell type of cell 553. Cell 553 may be of the same or of a different type as cell 543. Cell 553 may be of a different differentiation stage of cell 554. Cell 553 may or may not be a pluripotent cell. The second formulation comprises EVs 565. The second formulation can exit recoater interior space 552 through opening 555 towards platform 547 at least in part using the gravitational force of the ambient environment in which the 3D printer is disposed. Exit of the second formulation is not shown in example 540. At least during deposition of the second formulation, the second recoater can reversibly travel horizontally along direction 551. The first formulation may or may not be the same as the second formulation. In example 540, the first formulation is different from the second formulation.

At times, the printing of the synthetic plant cell-based construct involves using a combination of methodologies. In some cases, different methodologies may be used to manufacture different portions of the construct. In some examples, 3D printing methodologies comprise extrusion, wire, granular, laminated, light polymerization, or inkjet head 3D printing. The inkjet may utilize bioink. The bioink may comprise the formulation. The inkjet may use a physical force to direct the bioink. The physical force may comprise mechanical, magnetic, electromagnetic, electrical, piezoelectric, or pressure force. The extrusion may comprise micro extrusion bioprinting. The micro extrusion bioprinting may employ forces to extrude stream of the bioink. The forces may comprise the physical force. The extrusion or wire may comprise using a semi-solid (e.g., gel) bioink that is extruded, or generated into wires, respectively. Extrusion 3D printing can comprise robo-casting, fused deposition modeling (FDM) or fused filament fabrication (FFF). Powder bed and inkjet head 3D printing can comprise plaster-based 3D printing (PP). In the powder bed methodology, the bioink may be deposited as gel droplets that generate a powder like substance. Laminated 3D printing can comprise laminated object manufacturing (LOM). In the laminated 3D printing, the formulation may be cast into a laminar form, e.g., a planar sheet. Light polymerized 3D printing can comprise stereo-lithography (SLA), digital light processing (DLP), or laminated object manufacturing (LOM). 3D printing methodologies can comprise Direct Material Deposition (DMD). 3D printing methodologies can comprise fluid feed, wire feed, or powder feed. The 3D printing may comprise laser assisted bioprinting (LAB). The LAB may utilize laser pulses to propel bioink onto a target location.

In some embodiments a target is maintained. The target may be a fabricated plant product, e.g., a construct. The target may be a natural wood product. The target may be an old construct, e.g., an antique. The maintenance may utilize biological and/or bio-degradable formulation. The maintenance may comprise an external applications. The maintenance material may comprise a liquid, a semisolid (e.g., gel), a foam, a slurry, gas, or gas-borne phase. The gas borne phase may comprise an air borne phase. The gas borne phase may comprise an aerosol. The maintenance material may comprise Exomix. The maintenance material may comprise the formulation. The maintenance material may comprise depositing, or immersing, the target in the maintenance material. The external application may utilize any of the fabrication (e.g., manufacturing) methodologies disclosed herein, as applicable. The maintenance material (a) may be introduced into a channel receptable, (b) may comprise external wetting, or (c) any combination of (a) and (b). The external wetting may comprise depositing the maintenance material onto an external surface of the target. The external wetting may comprise submerging the target in the maintenance material. The external wetting may comprise spraying the target with the maintenance material, e.g., in an enclosure. The maintenance material can be introduced from one or more directions with respect to the target. The maintenance material can be introduced from a plurality of positions. At least two of the positions may be from the same direction with respect to the target. At least two of the positions may be from different directions with respect to the target. Introduction of the maintenance material from at least two of the different positions can be concerted. Introduction of the maintenance material from at least two of the different positions can be (e.g., substantially) simultaneous. Introduction of the maintenance material from at least two of the different positions can be sequential. The internal environment of the enclosure may have one or more environmental characteristics of the ambient environment external to the enclosure. The internal environment of the enclosure may have one or more environmental characteristics different from the ambient environment external to the enclosure. The one or more environmental characteristics may comprise pressure, temperature, gas makeup, gas type, gas pressure, relative gas content. In an example, the humidity in the enclosure during operation is higher than that of the ambient environment. In an example, the oxygen content in the enclosure during operation is higher than that of the ambient environment. In an example, the carbon dioxide content in the enclosure during operation is lower than that of the ambient environment. In an example, the temperature in the enclosure during operation is different (e.g., higher or lower) than that of the ambient environment. Higher or lower is understood to be in a measurable (e.g., detectable) amount. The internal environment of the enclosure may be in a standard temperature and pressure, e.g., about 25 degrees Celsius (° C.) and about one atmosphere.

In some embodiments, the methodologies disclosed herein allow maintenance of the at least one function of the living plant cells, is for a prolonged time. The maintenance is of a living cell in a plant product, e.g., fabricated using the formulation. The plant product may comprise a fabricated construct, or a maintenance of a target. The prolonged time may be longer than a respective commercial products. The prolonged time may be of at least about month(s), singular year(s), decade(s), a generation, half a century, or a century. Use of the formulation may extend the useful life of a product comprising plant cells. In an example, the use of the formulation extends the useful life of a product comprising wood cells wood product. The formulation may be added to a target to (a) maintain at least one of the plant cells of the target in a living state, and/or (b) impart properties to the target. The target may be a natural plant (e.g., wood), or a synthetic product comprising plant cells, e.g., as disclosed herein.

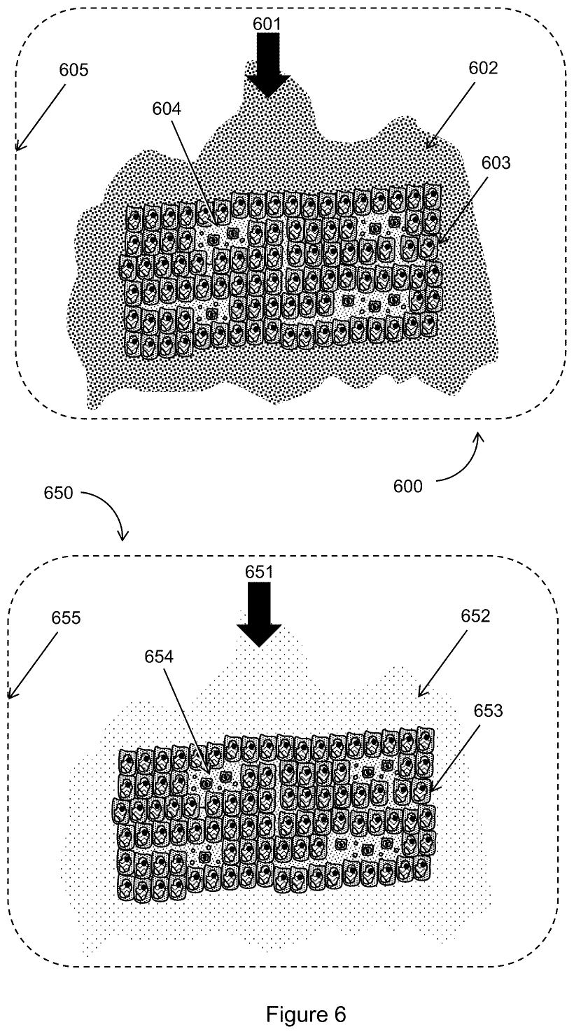

FIG. 6 shows examples of target maintenance. In example 600, a construct having cells such as 603 and niches such as 604 is subject to maintenance by immersion in a maintenance material 602, e.g., comprising Exomix in a liquid, or semi-solid form such as a gel. Maintenance material 602 is administered in direction 601 towards the target. While in example 600, maintenance material 602 is shown introduced from one direction 601, it may be introduced in any other direction or in any other directions, with respect to the target. Maintenance material 602 can be introduced from a plurality of positions. At least two of the positions may be from the same direction with respect to the target. At least two of the positions may be from different directions with respect to the target. The maintenance may be controlled, e.g., using any control system disclosed herein. At least one controller of the control system is operatively coupled, whether directly or indirectly, to effectuate the maintenance function(s). In example 650, a construct having cells such as 653 and niches such as 654 is subject to maintenance by immersion in a gas borne maintenance material 652, e.g., comprising Exomix. The maintenance material may be a medium that can be different from Exomix such as a supportive structure and/or a solution, e.g., as depicted in FIG. 1, 164. Maintenance material 652 is administered in direction 651 towards the target. While in example 650, maintenance material 652 is shown introduced from one direction 651, it may be introduced in any other direction or in any other directions, with respect to the target. Maintenance material 652 can be introduced from a plurality of positions. At least two of the positions may be from the same direction with respect to the target. At least two of the positions may be from different directions with respect to the target. The maintenance may be controlled, e.g., using any control system disclosed herein. At least one controller of the control system is operatively coupled, whether directly or indirectly, to effectuate the maintenance function(s).

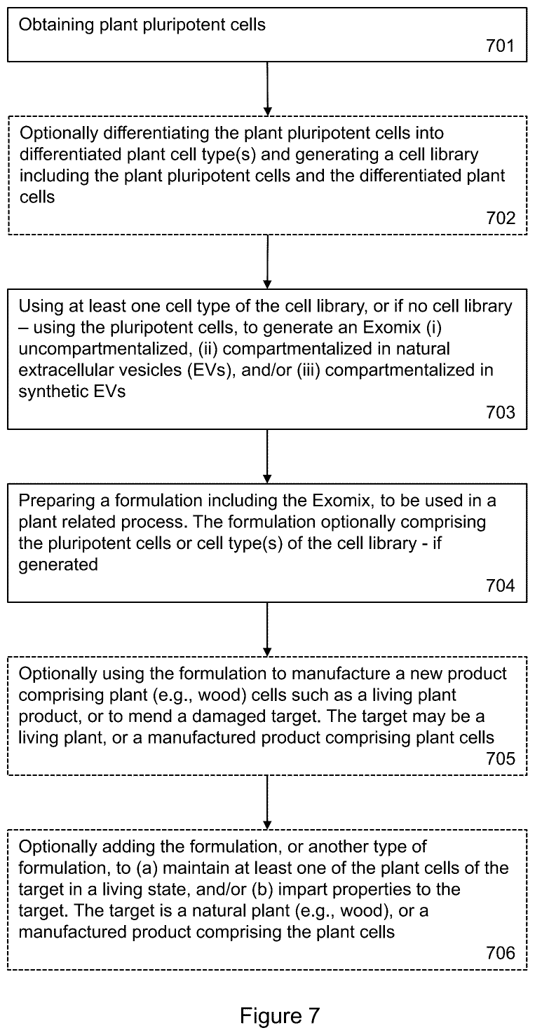

FIG. 7 shows an example of a flowchart depicting a methodology for using Exomix in a formulation for deposition, the method comprising (A) obtaining plant pluripotent cells in block 701; (B) optionally differentiating the plant pluripotent cells into differentiated plant cell type(s) and generating a cell library including the plant pluripotent cells and the differentiated plant cells in block 702; (C) using at least one cell type of the cell library, or if no cell library using the pluripotent cells, to generate an Exomix (i) uncompartmentalized, (ii) compartmentalized in natural extracellular vesicles (EVs), and/or (iii) compartmentalized in synthetic EVs, in block 703; (D) preparing a formulation including the Exomix, to be used in a plant related process, in block 704 (the formulation optionally comprising the pluripotent cells or cell type(s) of the cell library if generated); (E) optionally using the formulation to manufacture a new product comprising plant (e.g., wood) cells such as a living plant product, or to mend a damaged target (the target may be a living plant, or a manufactured product comprising plant cells), in block 705; and (F) optionally adding the formulation, or another type of formulation, to (a) maintain at least one of the plant cells of the target in a living state, and/or (b) impart properties to the target (the target is a natural plant (e.g., wood), or a manufactured product comprising the plant cells) in block 706.

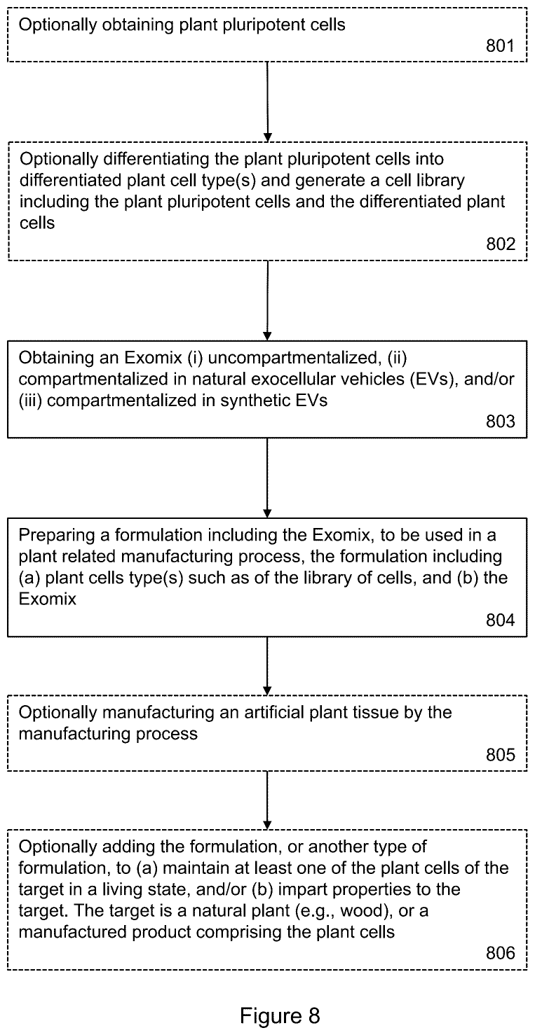

FIG. 8 shows an example of a flowchart depicting a methodology for fabricating a plant cell based product (e.g., a construct) comprising (A) optionally obtaining plant pluripotent cells in block 801; (B) optionally differentiating the plant pluripotent cells into differentiated plant cell type(s) and generate a cell library including the plant pluripotent cells and the differentiated plant cells, in block 802; (C) obtaining an Exomix that is (i) uncompartmentalized, (ii) compartmentalized in natural extracellular vehicles (EVs), and/or (iii) compartmentalized in synthetic EVs, in block 803; (D) preparing a formulation including the Exomix, to be used in a plant related manufacturing process, the formulation including (a) plant cells type(s) such as of the library of cells, and (b) the Exomix, in block 804; (E) optionally manufacturing an artificial plant tissue by the manufacturing process, in block 805; and (F) optionally adding the formulation, or another type of formulation, to (a) maintain at least one of the plant cells of the target in a living state, and/or (b) impart properties to the target (the target is a natural plant (e.g., wood), or a manufactured product comprising the plant cells), in block 806. Obtaining the Exomix may be as described herein, e.g., from a cell of the plant cell library.

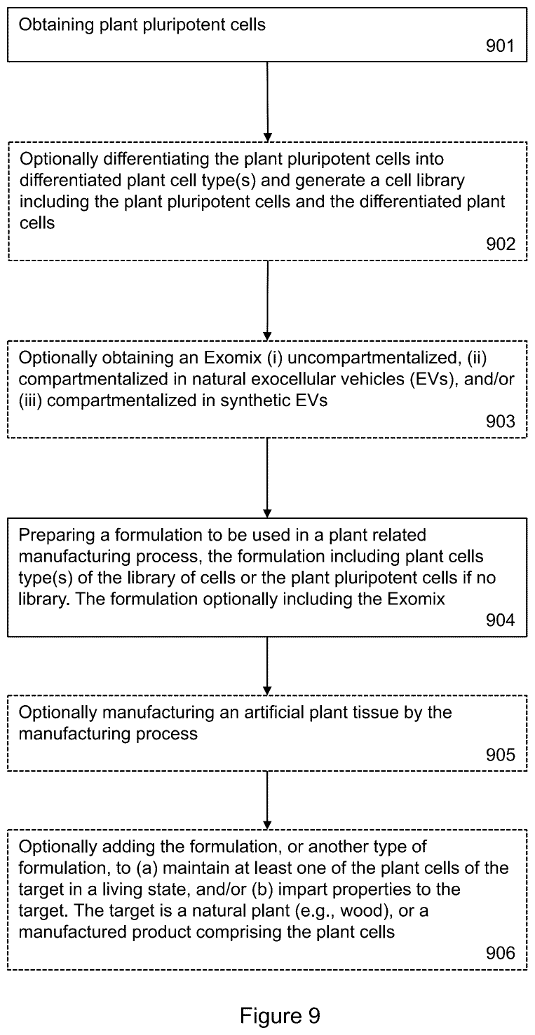

FIG. 9 shows an example of a flowchart depicting a methodology for fabricating a plant cell based product (e.g., a construct) comprising (A) optionally obtaining plant pluripotent cells, in block 901; (B) optionally differentiating the plant pluripotent cells into differentiated plant cell type(s) and generate a cell library including the plant pluripotent cells and the differentiated plant cells, in block 902; (C) optionally obtaining an Exomix (i) uncompartmentalized, (ii) compartmentalized in natural extracellular vehicles (EVs), and/or (iii) compartmentalized in synthetic EVs, in block 903; (D) preparing a formulation to be used in a plant related manufacturing process, the formulation including plant cells type(s) of the library of cells or the plant pluripotent cells if no library (the formulation optionally including the Exomix) in block 904; (E) optionally manufacturing an artificial plant tissue by the manufacturing process, in block 905; and (F) optionally adding the formulation, or another type of formulation, to (a) maintain at least one of the plant cells of the target in a living state, and/or (b) impart properties to the target. The target is a natural plant (e.g., wood), or a manufactured product comprising the plant cells, in block 906. Obtaining the Exomix may be as described herein, e.g., from a cell of the plant cell library.

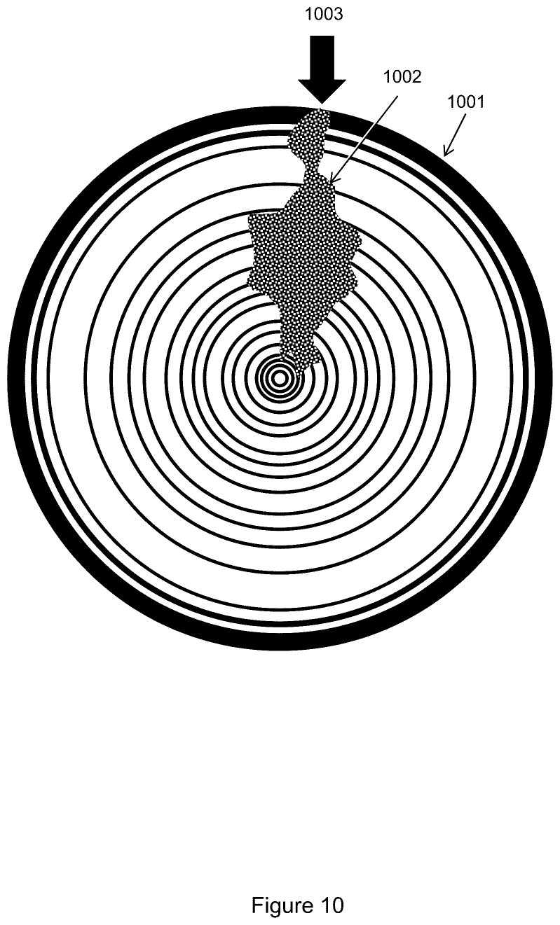

FIG. 10 shows a schematic example of a horizontal cross section of a damaged target. The damaged target is a trunk of natural wood shown as horizontal cross section 1001. The damaged area of the target is filled with formulation 1002, e.g., any formulation disclosed herein such as comprising Exomix. Arrow 1003 designates a direction by which the formulation may be administered into the damaged wood trunk.

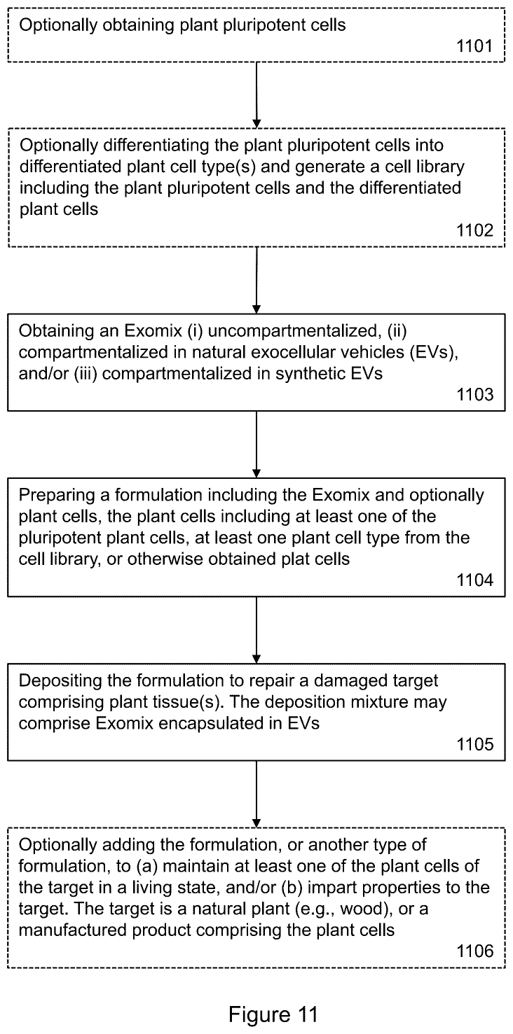

FIG. 11 shows an example of a flowchart depicting a methodology for repair and/or revival of a target (e.g., a natural plant) comprising (A) optionally obtaining plant pluripotent cells, in block 1101; (B) optionally differentiating the plant pluripotent cells into differentiated plant cell type(s) and generate a cell library including the plant pluripotent cells and the differentiated plant cells, in block 1102; (C) obtaining an Exomix (i) uncompartmentalized, (ii) compartmentalized in natural extracellular vehicles (EVs), and/or (iii) compartmentalized in synthetic EVs, in block 1103; (D) preparing a formulation including the Exomix and optionally plant cells, the plant cells including at least one of the pluripotent plant cells, at least one plant cell type from the cell library, or otherwise obtained plant cells, in block 1104; (E) depositing the formulation to repair a damaged target comprising plant tissue(s) (the deposition mixture may comprise Exomix encapsulated in EVs), in block 1105; and (F) optionally adding the formulation, or another type of formulation, to (a) maintain at least one of the plant cells of the target in a living state, and/or (b) impart properties to the target (the target is a natural plant (e.g., wood), or a manufactured product comprising the plant cells), in block 1106. Obtaining the Exomix may be as described herein, e.g., from a cell of the plant cell library.

In some embodiment, plant related products are generated such as manufactured. The plant related products may be generated from any of the plant cells disclosed herein, e.g., from the library of plant cells. The plant related products may be generated from the formulation, or by otherwise utilizing the formulation. The plant related products may be harvested from the plant cells and/or from the formulation. The plant related products may be harvested from the plant cell tissue fabricated using any of the methodologies disclosed herein. In an example, the plant related products may be harvested from a plant cell tissue fabricated using 3D printing. The plant related products may be utilized for purpose(s) comprising medicine, cosmetics, perfume, bioplastics. The plant related product may compromise resins, tanins, gum, wax, oils, fire retardants, pharmaceuticals, or health supplements. The plant related product may be harvested using any applicable harvesting methodology. The harvesting methodology may comprise extraction. The extraction may comprise chemical or physical extraction. The physical extraction may comprise extraction using a pressure gradient. The extraction may comprise gravitational extraction. The extraction may comprise centrifugation. The extraction may comprise pressurized liquid extraction (PLE). The extraction may comprise electric field extraction (EFE). The extraction may comprise sound wave assisted extraction such as ultrasound assisted extraction (UAE). The extraction may comprise electromagnetic wave assisted extraction such as microwave assisted extraction (MAE). The chemical extraction may comprise solvent assisted extraction. The extraction may comprise Soxhlet extraction, titration, or column separation. The chemical extraction may comprise liquid-liquid extraction, acid-base extraction, supercritical fluid extraction, or pressurized liquid extraction. One or more extraction methodologies may be utilized in the harvesting methodology. The plant-related product generation may be controlled, e.g., using any control system disclosed herein. At least one controller of the control system is operatively coupled, whether directly or indirectly, to effectuate the function(s) of the plant related product generation.

In some embodiments, the system, device, and/or apparatus disclosed herein comprises a control system. The control system may comprise one or more controllers. The control system may comprise, or be operatively coupled with, one or more devices, apparatuses, and/or systems of the mechanism (e.g., system, device or apparatus) disclosed herein, including any component of the device(s), apparatuses(s), and/or system(s). The controller(s) may comprise, or be operatively coupled with, a hierarchical control system. The hierarchical control system may comprise at least three, four, or five, control levels. In some embodiments, at least two operations are performed, or directed, by the same controller. In some embodiments, at least two operations are each performed, or directed, by a different controller. A control system may comprise a control system. A control system may comprise a laser control system. The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. The control system may comprise, or be operatively coupled with, a metrological detection system and configured to receive measurement data from the metrological detection system. The control system may be configured to generate control signals responsive to the measurement data collected by the metrological detection system.

In some embodiments, the systems, apparatuses, devices, and/or components thereof disclosed herein comprise one or more controllers. One or more operations of any of the methodologies disclosed herein, may be effectuated by at least one controller (e.g., of the control system), the controller being operatively coupled with at least one component that executes the one or more operations, whether directly or indirectly. The at least one controller may comprise one or more processors. The at least one controller may comprise a computational scheme, or program instructions (e.g., configured in a processor readable code).

The one or more controllers can comprise one or more central processing unit (CPU), input/output (I/O) and/or communications module. The CPU can comprise electronic circuitry that carries out instructions of a computer program by performing arithmetic, logic, control and I/O operations specified by the instructions. The controller can comprise a suitable software (e.g., operating system). The control system may optionally include a feedback control loop and/or feed-forward control loop. The controllers may be shared between one or more systems or apparatuses. Each apparatus or system may have its own controller. Two or more systems and/or its components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller system may comprise a single input single output controller (SISO) or a multiple input multiple output controller (MIMO). The controller may interpret the input signal received. The controller may acquire data from one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer.

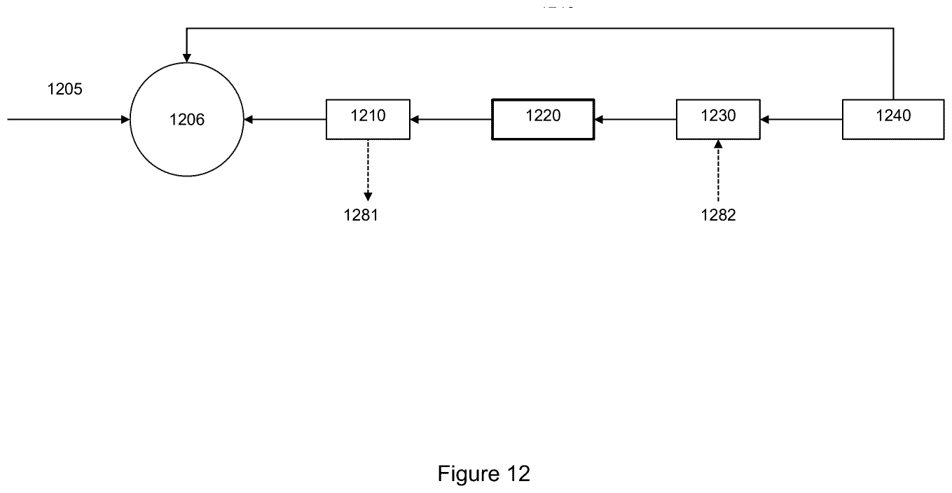

FIG. 12 shows a schematic example of process 1220 controlled using a control system in a feedback loop control scheme, e.g., in a closed loop control scheme. The control system receive set point 1205 to comparator 1206 that generates an error signal, which is fed 1245 into controller 1240. In other control systems, the comparator is part of the controller. Controller 1240 generates a control signal that is fed into controlling element 1230. The controlling element may comprise a mechanism utilized for its control function to control process 1220. Controlling element 1230 provides an input to process 1220. The mechanism may effectuate a physical and/or a chemical change, which change is the input to process 1220. The physical change may comprise mechanical change, magnetic change, electromagnetic change, piezoelectric change, electrical change, pressure change, or temperature change. The chemical change may comprise a change in a chemical gradient, or in a chemical entity. Process 1220 can be any process disclosed herein, e.g., any method such as a fabrication method. Process 1220 generates an output detected by measuring element 1210, e.g., using its sensor(s). The output provided by process 1220 may be a reaction of the process to the input provided by control element 1230. Measuring element 1210 generates a variable amplitude signal that is fed back into comparator 1206 and is again compared with the setpoint. Measuring element 1210 optionally also generates a controlled variable 1281. Control element 1230 optionally also receives a manipulated variable 1282, e.g., from an external source such as a processor and/or a communication system. Sensor(s) can be used by measuring element 1210 for the measurement of parameters of the process, e.g., 1220. The sensor measurement can be a determination of an amplitude of a parameter such as of a material, e.g., as disclosed herein. In an example, the value of the measurement is consistent and repeatable. The sensor(s) can convert the physical parameters (e.g., repeatedly and reliably) into a usable form by the control system, e.g., into an electrical signal such as in a digital form. The comparator can perform an error detection, e.g., by determining a difference between the amplitude of the measured variable and a requested set reference point (e.g., set point 1205), which difference is the error signal. The error signal can be amplified and/or conditioned such as filtered. The signal amplification and/or conditioning may be performed by an external component to the controller (e.g., 1240), or within the controller. The reference point (e.g., set point) can be stored in the memory of the controller, or of a memory operatively coupled with the controller. The controller can be a (e.g., micro-) processor-based system that can determine the next operation to be taken in a process. The process may be sequential. The controller may evaluate the error signal in a continuous process control system, e.g., to determine what action is to be taken. The controller (e.g., 1240) can condition the signal, or be operatively coupled with a unit conditioning the system. Conditioning the signal may comprise noise filtering. Conditioning the signal may comprise correcting the signal for a non-linearity in the sensor. The controller may include the parameters of the process input control element. The controller may condition the error signal to direct the control element, e.g., 1230. The controller can monitor input signal(s). The input signals may be interrelated. The controller may be configured to direct at least two control elements in concert. The controller may be configured to direct at least two control elements simultaneously. The controller may be configured to direct at least two control elements sequentially. The control element (e.g., 1230) can be a device that controls an incoming material to the process, or any other attribute of the process comprising physical attribute or chemical attribute. The physical attribute may comprise mechanical, magnetic, piezoelectric, electromagnetic, electrical, pressure, or temperature attribute. The chemical attribute may comprise a chemical gradient, or in a chemical entity. The control element can be a flow control element. The control element can be a temperature control element. The control element can have toggle (e.g., On/Off) characteristics. The control element can provide linear, or non-linear, control of the control element. The control element can be used to adjust the input to the process, e.g., bringing the output variable to the value of the set point. The measuring element (e.g., 1210) can consists of sensor(s) to measure the physical property of a variable, a transducer to convert the sensor signal into an electrical signal, and/or a transmitter to amplify the electrical signal. The amplification of the signal can be transmitted with minimal (e.g., without measurable) loss. The control element may comprise an actuator which changes the electrical signal from the controller into a signal to operate and/or control a physical device such as a valve. The controller may comprise a memory or be operatively coupled with a memory. The control system may comprise a summing circuit, e.g., to compare the set point to the sensed signal, so that it can generate the error signal. The summing circuit may be part of the comparator. The controller may use the error signal to generate a correctional signal to control the control element. In an example, the controller controls a valve via an actuator and the input variable. The sensors of the measuring element may comprise optical sensors, temperature sensors, pressure sensors, chemical sensors, proximity sensors, viscosity sensor, chemical sensors, or any other sensor disclosed herein. The chemical sensors may sense a material comprising oxygen, water, or any other chemical disclosed herein. The sensors may be configured to sense one or more attributes of the methods disclosed herein such as the fabrication methods.

Control may comprise regulate, modulate, adjust, maintain, alter, change, govern, manage, restrain, restrict, direct, guide, oversee, manage, preserve, sustain, restrain, temper, or vary.

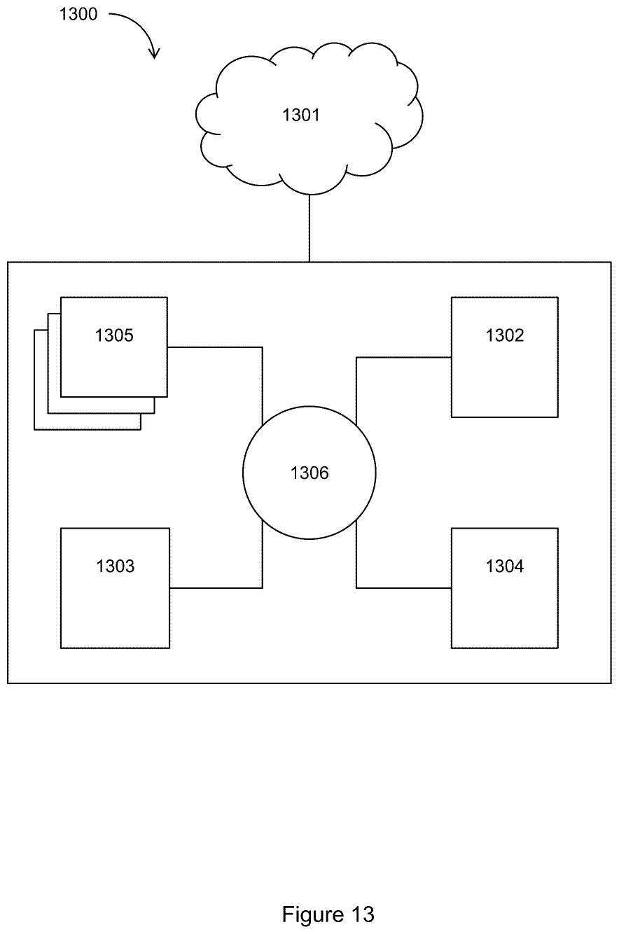

In some embodiments, the device, system, and/or apparatus disclosed herein comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor may be programmed to implement methods of the disclosure. The controller may control at least one component of the systems and/or apparatuses disclosed herein. FIG. 13 shows a schematic example of a computer system 1300 that is programmed or otherwise configured to facilitate execution any of the methods provided herein. The computer system 1300 can control (e.g., direct, monitor, and/or regulate) various features of the methods, apparatuses, devices and/or systems of the present disclosure. The computer system 1300 can be part of, or be in communication with, the device, system and/or apparatus disclosed herein. The computer may be coupled with one or more mechanisms disclosed herein, and/or any parts thereof. The computer system 1300 can include a processing unit 1306 (also “processor,” “computer” and “computer processor” used herein). The computer system may include memory or memory location 1302 (e.g., random-access memory, read-only memory, flash memory), electronic storage unit 1304 (e.g., hard disk), communication interface 1303 (e.g., network adapter) for communicating with one or more other systems, and peripheral devices 1305, such as cache, other memory, data storage and/or electronic display adapters.

The memory 1302, storage unit 1304, interface 1303, and peripheral devices 1305 are in communication with the processing unit 1306 through a communication bus (solid lines), such as a motherboard. The storage unit can be a data storage unit (or data repository) for storing data. The computer system can be operatively coupled with a computer network (“network”) 1301, e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server. The processing unit can execute a sequence of machine-readable instructions, which can be embodied in a program or software. The instructions may be stored in a memory location, e.g., memory 1302. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system (e.g., 1300) can be included in the circuit.

In some embodiments, the storage unit (e.g., 1304) stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet. The processor may be configured to process control protocols, e.g., communicate with one or more components of the mechanism (e.g., device, apparatus, and/or system) disclosed herein using the control protocols. Control protocols can be one or more of the internet protocol suite, e.g., transmission control protocol (TCP) or transmission control protocol/internet protocol (TCP/IP). Control protocols can be one or more serial communication protocols. Control protocols can be one or more of controller area networks or another message-based protocol, e.g., for communication with microcontrollers and devices. Control protocols can interface with one or more serial bus interfaces for communication with the mechanism disclosed herein, e.g., with any of its components. The control protocol can be any control protocol disclosed herein.

In some embodiments, the system, device, and/or apparatus disclosed herein comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory 1302 or electronic storage unit 1304. The machine executable or machine-readable code can be provided in the form of software. During use, the processor (e.g., 1306) can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine that has a processer adapted to execute the code or can be compiled during runtime. The code can be supplied in a programming language that can be selected to enable the code to execute in a pre-compiled or as-compiled fashion.

In some embodiments, the computer system utilizes a machine readable medium/media to execute, or direct execution of, operation(s). The program instructions can be inscribed in a machine executable code. A machine-readable medium/media, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some embodiments, the device, system, and/or apparatus disclosed herein comprises, or is operatively coupled with, a communication technology, e.g., in addition to the optical fiber disclosed herein. The communication may comprise wired or wireless communication. For example, the systems, apparatuses, and/or parts thereof may comprise Bluetooth, wi-fi, global positioning system (GPS), or radiofrequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro or mini-USB. The surface identification mechanism may comprise a plug and/or a socket, e.g., electrical, AC power, DC power. The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

### Synthetic Living Wood Tissue Fabrication and Restoration System

In some embodiments, the synthetic living wood tissue fabrication and restoration system can integrate a wet-lab preparation module that generates bio-active formulations comprising plant cells and an Exomix formulation with optional encapsulation to prime constructs for growth and function. More specifically, the synthetic living wood tissue fabrication and restoration system can incorporate additive manufacturing hardware that performs three-dimensional printing or layer-wise deposition to fabricate synthetic living wood tissue or to repair damaged regions of existing wood articles using extrusion and/or inkjet deposition processes. Additionally, the synthetic living wood tissue fabrication and restoration system can deploy environmental and process monitoring subsystems with sensors that measure temperature, humidity, gas composition, and process variables such as deposition rate and cell viability to maintain suitable fabrication and maintenance conditions. Furthermore, the synthetic living wood tissue fabrication and restoration system can implement control electronics that execute open-loop and/or closed-loop feedback schemes to regulate fabrication and maintenance operations according to real-time measurements. In particular, the synthetic living wood tissue fabrication and restoration system can include maintenance delivery equipment that administers bio-active formulations by spraying, immersion, and/or targeted channel injection to sustain viability and function during post-fabrication periods. In one implementation, the synthetic living wood tissue fabrication and restoration system can operate in batch or continuous modes and can utilize an enclosure to stabilize internal environmental parameters during fabrication or maintenance. In another implementation, the synthetic living wood tissue fabrication and restoration system can configure workflows to support multiple plant cell types, diverse Exomix compositions, varied encapsulation strategies, and alternative deposition methods to tailor mechanical and biological performance. Moreover, the synthetic living wood tissue fabrication and restoration system can employ a hierarchical control architecture with distributed and/or centralized control layers that connect to remote or cloud-based computational resources for optimization and data logging. Thus, the synthetic living wood tissue fabrication and restoration system addresses decay in non-living wood, enables imparting non-natural or enhanced properties, reduces reliance on unsustainable sourcing through regenerative fabrication, supports environmentally favorable operations, and restores or sustains living functionality in both newly engineered and existing wood products.

### Synthetic Wood Tissue Fabrication and Maintenance Method

In some embodiments, the synthetic wood tissue fabrication and maintenance method can initiate by obtaining plant cell population and Exomix formulation and by combining the biological building blocks into a deposition-ready composition with rheological and compositional properties configured to support viability and function. The synthetic wood tissue fabrication and maintenance method can fabricate a multi-cellular construct from the composition according to additive manufacturing and/or molding and casting and can arrange spatially defined niches and microfluidic or macro-scale channels to facilitate nutrient, gas, and signaling transport. The synthetic wood tissue fabrication and maintenance method can integrate a fabricated construct with a target wood substrate according to direct deposition, adhesive bonding, or infiltration and can employ environmental control of humidity, temperature, and gas composition during and after integration to promote survival and maturation. The synthetic wood tissue fabrication and maintenance method can maintain living function by applying maintenance formulations via immersion, spraying, or channel-based perfusion according to a periodic or continuous regimen that targets operational lifetimes ranging from months to decades. The synthetic wood tissue fabrication and maintenance method can harvest secondary bioproducts from an integrated living wood structure according to solvent extraction, centrifugation, and/or pressure-driven methods while preserving structural integrity. The synthetic wood tissue fabrication and maintenance method can implement open-loop or closed-loop process control with sensors, actuators, and controllers that monitor and adjust parameters locally and/or via remote computing resources to maintain a controlled process environment. The synthetic wood tissue fabrication and maintenance method can broadly encompass preparation of a living plant cell-based formulation, fabrication of a multi-cellular construct, integration with a wood product or substrate, maintenance of living function over time, and optional harvesting and automated control, while narrower embodiments can specify particular cell types, Exomix compositions, encapsulation strategies, fabrication techniques, integration protocols, maintenance regimens, product harvesting methods, and control architectures. Therefore, the synthetic wood tissue fabrication and maintenance method addresses decay of dead wood tissue by restoring living function within wood products, enables non-natural or enhanced properties through programmable formulations and construct architectures, supports sustainable sourcing by extending service life and enabling repair over replacement, promotes environmentally friendly manufacturing through biologically mediated processing, and overcomes an inability to sustain or regenerate living wood tissue by maintaining viability and function over extended periods.

### 1. Prepare Biological Inputs

In some embodiments, the cell source module can execute 1. prepare biological inputs to obtain and condition biological materials for fabrication, maintenance, and/or repair of synthetic living wood tissue. The plant pluripotent cell supply can isolate pluripotent cells from a donor plant tissue sample sourced from natural plants, genetically engineered plants, and/or plant biowaste, and the plant pluripotent cell supply can expand stem-cell populations under controlled ranges (e.g., temperature between 18 and 30° C., relative humidity between 40% and 80%, dissolved oxygen between 20% and 60% air saturation, and nutrient concentrations within predefined ranges) to increase viable cell numbers. The cell source module can direct targeted differentiation of an expanded pluripotent cell population into one or more differentiated plant cell population, such as parenchyma, collenchyma, sclerenchyma, xylem, and/or phloem, by adjusting culture media composition and by applying an Exomix signaling exposure schedule. The exomix production module can generate an Exomix signaling cocktail from a conditioned plant cell culture medium and/or from synthetic precursors, where the Exomix signaling cocktail can include signaling molecules, nutrients, nucleic acids, proteins, lipids, and other bioactive compounds configured to guide plant cell behavior. The encapsulation unit can encapsulate the Exomix signaling cocktail via a natural EV isolation stage and/or a synthetic EV fabrication stage to produce encapsulated vesicles with tunable membrane composition and release kinetics for localized delivery. The library storage subsystem can curate libraries of plant cell types and Exomix formulation with associated metadata that describe mechanical, biochemical, and integration outcomes to enable selection of specific combinations that impart desired properties to downstream constructs. The formulation preparation subsystem can output a plant cell population and an Exomix formulation that are conditioned for subsequent use in 2. formulate bio-ink/supplement mixture, while the library storage subsystem can retain archived variants for later retrieval. Therefore, the cell source module, the Exomix production module, the encapsulation unit, and the library storage subsystem can collectively provide scalable, selectable, and controllable living inputs that enable regeneration of wood interfaces to mitigate decay, enable selection of inputs that impart enhanced or non-natural properties, reduce reliance on harvested timber by utilizing cell expansion and biowaste sourcing, and support low-temperature aqueous processing that aligns with environmentally friendly manufacturing.

### 2. Formulate Exomix: Bio-Ink/Supplement Mixture

In some embodiments, the formulation preparation subsystem can execute 2. formulate bio-ink/supplement mixture by directing the formulation mixing module to combine a plant cell population, an Exomix formulation, and a supportive matrix/scaffold material to yield abio-ink/supplement mixture suitable for deposition and/or infusion. More specifically, the formulation mixing module can mix pluripotent and/or differentiated plant cell population at an exemplary density between 1×10\hat{ }6 and 2×10\hat{ }8 cells per mL with an Exomix formulation that includes bioactive proteins, lipids, nucleic acids, and metabolites in non-encapsulated form and/or as encapsulated Exomix vesicles sourced from the encapsulation unit at an exemplary particle concentration between 1×10\hat{ }8 and 5×10\hat{ }11 particles per mL. In particular, the supportive matrix preparation unit can prepare a hydrogel and/or polymer scaffold, such as alginate, cellulose nanofibrils, lignin-derived polymers, and/or gelatinized hemicellulose, at an exemplary bulk concentration between 0.3% and 5% (w/v) so that the formulation mixing module can achieve a target rheological profile with a low-shear viscosity between 0.5 and 20 Pas and a shear-thinning index between 0.2 and 0.7. In one implementation, the environmental control module can maintain a controlled process environment that configures the temperature controller to hold 18-28° C., the humidity controller to sustain 60-95% relative humidity, and the gas composition controller to regulate oxygen between 2% and 21% and carbon dioxide between 0.04% and 5% so that the formulation preparation subsystem can preserve viability and signaling functionality during mixing. Additionally, the formulation mixing module can adjust pH to an exemplary range of 5.2-6.2, osmolarity to an exemplary range of 200-450 mOsm/kg using sucrose and/or mannitol, ionic strength to an exemplary conductivity of 5-20 mS/cm, and nutrient levels to an exemplary sucrose content of 1-3% (w/v) and nitrogen sources between 5 and 30 mM to promote proliferation and/or differentiation after deposition. Alternatively, in a synthetic-only signaling variant, the formulation preparation subsystem can substitute synthetic EVs from the synthetic EV fabrication stage and exclude natural EVs from the natural EV isolation stage while maintaining equivalent rheological and viability targets. Then, the formulation mixing module can output a deposition-ready bio-ink mixture with a nozzle-compatible yield stress between 50 and 500 Pa for additive manufacturing and/or an injection-ready supplement mixture with a viscosity between 50 and 5000 mPas for channel infusion or site repair, thereby providing compatibility with the additive manufacturing subsystem and the delivery mechanism. Generally, the formulation preparation subsystem can perform all mixing and conditioning steps under sterile conditions, such as ISO Class 5-7 enclosures, so that the formulation preparation subsystem can prevent contamination and preserve functional properties of the bio-ink/supplement mixture Thus, the formulation preparation subsystem addresses the inability to sustain or regenerate living wood tissue by preparing a cell-Exomix-matrix composition that maintains viability and controlled signaling, addresses decay and lack of enhanced properties by enabling precise additive manufacturing of reinforced and functionalized constructs, and addresses sustainability and environmentally friendly processing by utilizing aqueous, low-toxicity matrices that reduce reliance on harvested wood materials.

### 3. Fabricate Synthetic Wood Tissue

In some embodiments, the fabricate synthetic wood tissue step can shape a bio-ink/supplement mixture into a three-dimensional synthetic living wood tissue construct by coordinating a fabrication apparatus that deposits and conditions material in a controlled process environment. More specifically, the additive manufacturing subsystem can deposit the bio-ink/supplement mixture in a layer-wise and/or volumetric manner by actuating a recoater assembly across a build platform while a vertical translation mechanism advances a build height according to a fabrication technique configuration. In particular, the formulation feed reservoir can meter one or more formulations at adjustable flow rates to enable sequential or simultaneous deposition of distinct cellular compositions and Exomix concentrations that define region-specific functionality. Also, the environmental control module can regulate deposition rate dependencies by adjusting a temperature controller, a humidity controller, and a gas composition controller to maintain viability ranges (e.g., exemplary 18-28° C. temperature, 60-95% relative humidity, and oxygen/carbon dioxide ratios suited for plant cell respiration) during fabrication. Additionally, the control system can maintain spatial fidelity and biofunction by using a processing unit to fuse a real-time sensor data stream from a sensors array and by commanding actuators and drivers via feedback loop circuitry to correct toolpaths, pressures, and dwell times. Furthermore, the synthetic plant tissue construct can incorporate niche reservoirs that localize distinct bioactive payloads and can integrate a microfluidic channel network that distributes nutrients, Exomix formulation, and/or cells throughout a cellular matrix to emulate transport pathways. Then, the 3. fabricate synthetic wood tissue step can place pluripotent and/or differentiated plant cell population in patterns that emulate xylem, phloem, cambium, and parenchyma domains so that anatomical organization supports respiration, nutrient transport, and self-maintenance. Alternatively, the supportive matrix/scaffold material can provide temporary or persistent structural reinforcement. In another variant, the synthetic-only signaling variant can enable use of a synthetic Exomix formulation and/or encapsulated exomix vesicles without reliance on natural EVs to create tailored signaling gradients during deposition. Finally, the synthetic living wood tissue construct can express target properties during and after 3. fabricate synthetic wood tissue, including decay resistance via localized antimicrobial or enzymatic zones, enhanced mechanical strength via anisotropic fiber alignment, and tuned electrical, thermal, or olfactory characteristics via region-specific additives; therefore, the 3. fabricate synthetic wood tissue step can directly address decay of dead wood tissue, inability to regenerate living function, and lack of methods to impart enhanced properties while supporting environmentally friendly manufacturing that can reduce unsustainable wood sourcing.

### 4. Integrate or Repair Target Structures

In some embodiments, the maintenance and repair delivery subsystem can execute 4. integrate or repair target structures by aligning a synthetic living wood tissue construct and/or a bio-ink/supplement mixture with a target wood substrate to generate a formulation-impregnated wood interface that transitions to an integrated living wood structure. More specifically, the delivery mechanism can position the synthetic living wood tissue construct adjacent to voids, cracks, and decayed regions and can inject or infuse the bio-ink/supplement mixture through a channel injection probe and/or a spray/aerosol unit to conformally fill irregular geometries, while an immersion chamber can soak porous substrates to promote deep penetration. In particular, the formulation preparation subsystem can tailor cellular composition and extracellular matrix content of a synthetic plant tissue construct to match anatomical and mechanical features of the target wood substrate, and the synthetic plant tissue construct can present engineered surface topography and/or interlocking geometries that promote mechanical continuity. Additionally, the formulation preparation subsystem can incorporate a bio-compatible adhesive excipient and/or a fibrillating binder into the deposition-ready bio-ink mixture to increase initial adhesion strength while the microfluidic channel network can promote subsequent biological continuity. Then, the environmental control module can condition a controlled process environment with temperature between a target range (e.g., 10-35° C.), relative humidity between a target range (e.g., 40-95% RH), and oxygen concentration between a target range (e.g., 5-21% v/v) to maintain cell viability during placement and early integration. Alternatively, the control system can coordinate the sensors array to capture a real-time sensor data stream that quantifies interface wetting, infusion depth, and early metabolic signals, and the processing unit can derive application site characterization data and/or quality metrics to validate bond formation. Subsequently, the maintenance and repair delivery subsystem can apply post-integration treatments that include nutrient supplementation, low-shear incubation, and staged environmental conditioning to support maturation toward the integrated living wood structure. Thus, the maintenance and repair delivery subsystem and the environmental control module can restore biological and mechanical function in damaged or manufactured wood products to counter wood tissue decay, can enable integration of enhanced-property synthetic living wood tissue to impart non-natural performance, and can reduce reliance on harvested lumber by enabling in situ regeneration using aqueous, low-energy conditions that support environmentally friendly processing.

### 6. Harvest Secondary Bioproducts

In some embodiments, the synthetic living wood tissue construct can secrete secondary metabolites, and the microfluidic channel network can route secreted compounds toward niche reservoirs to stage collection without disrupting a cellular matrix. The immersion chamber can execute 6.1 extract biochemical outputs by contacting the synthetic living wood tissue construct and/or a surrounding medium with physical, chemical, and/or enzymatic modalities tailored to resin, tannin, and bio-polymer recovery. The delivery mechanism can apply mechanical pressing, centrifugation, and/or filtration to separate bioproducts from a crude biochemical extract while the environmental control module maintains a controlled process environment that preserves viability. The exomix production module can execute 6.2 purify and store extracts by applying solvent systems (e.g., aqueous, organic, or supercritical fluids) and enzyme-assisted release to convert a crude biochemical extract into harvested biochemical extracts suitable for external applications. The control system can schedule in situ or ex situ harvest cycles at defined intervals and can adjust cycle timing according to viability and function metrics data to avoid compromising a structural integrity of the integrated living wood structure. The library storage subsystem can register harvested biochemical extracts with metadata and can coordinate downstream transfer to application-specific packaging maintained by the formulation preparation subsystem. Thus, the synthetic wood tissue fabrication and maintenance method can valorize co-products in a closed loop, which reduces reliance on extractive forestry and supports environmentally friendly manufacturing while sustaining the synthetic living wood tissue for repeated use.

### 7. Monitor and Control Process

In some embodiments, the control system can execute 7. monitor and control process by coordinating supervisory, intermediate, and local controllers to maintain a controlled process environment across formulation preparation, additive manufacturing, maintenance, and repair operations. More specifically, the sensors array can generate a real-time sensor data stream that measures temperature, humidity, oxygen level, pH, nutrient concentration, and/or flow rate within the fabrication apparatus and the maintenance and repair delivery subsystem. In particular, the processing unit can process the real-time sensor data stream with feedback loop circuitry and optionally a feedforward model to compute a control action command set relative to predefined setpoints or ranges. Additionally, the actuators and drivers can apply the control action command set by modulating pumps, valves, heaters, and environmental regulators to correct deviations detected by the feedback loop circuitry. Further, the environmental control module can regulate the controlled process environment by commanding the temperature controller, the humidity controller, and the gas composition controller to track setpoints during 3. fabricate synthetic wood tissue and 5. maintain and sustain living tissue. In one implementation, the processing unit can interface with metrological detection systems and analytics alerts and recommendations to adapt control gains and timing for transient and steady-state disturbances. Alternatively, the control system can distribute computation across on-board hardware and remote or cloud-based components to coordinate 1. prepare biological inputs, 1.5 encapsulate Exomix for controlled delivery, and 2. formulate bio-ink/supplement mixture in parallel with 4. integrate or repair target structures. In one embodiment, the control system can enable manual override via user interfaces such that an operator may adjust setpoints or authorize control action command set execution while viewing archived process data set trends. Also, the processing unit can log the real-time sensor data stream and applied control action command set to 7.3 data logging and analytics for process optimization and adaptive control. Then, the control system can maintain a controlled process environment that results in stable rheology during 2.3 tune rheology and viability, consistent layer quality during 3.2 deposit construct layers, and sustained microenvironmental parameters within the synthetic plant tissue construct during 3.4 post-fabrication maturation. Thus, the control system can reduce decay of wood analogs by maintaining viable conditions, can enable property enhancement by holding precise fabrication parameters, can support environmentally friendly operation by minimizing waste and energy through closed-loop regulation, and can sustain or regenerate living wood tissue by continuously stabilizing growth-relevant variables.

In certain embodiments, the bio-ink formulation of the present disclosure comprises a hydrogel matrix engineered to emulate the structure and function of native plant cell walls. The hydrogel provides a hydrated, mechanically tunable environment that promotes cell adhesion, viability, and lineage-specific differentiation of plant precursor cells into cambial, xylem-like, or phloem-like phenotypes. The hydrogel may be composed of cellulose nanofibers, low-methoxyl pectin, sodium alginate, xyloglucan, and compatible nutrient and ionic components.

In certain embodiments, the hydrogel matrix comprises cellulose nanofibers, pectin, alginate, and xyloglucan, formulated to support plant vascular differentiation and to retain extracellular vesicles for controlled signal release. This specific combination and application differ from known mammalian or food-grade hydrogels by enabling plant-cell adherence, long-term viability, and in situ lignification.

In some embodiments, a representative formulation includes from about 0.5 to about 1.2 percent by weight cellulose nanofibers, from about 1.0 to about 1.5 percent low-methoxyl pectin, from about 0.3 to about 0.7 percent sodium alginate, and from about 0.1 to about 0.3 percent xyloglucan such as tamarind-derived polysaccharide. These polysaccharides are dispersed in a nutrient medium containing approximately 0.25× to 0.5× Murashige and Skoog salts, vitamins, and about two percent sucrose to maintain osmotic balance. The mixture is adjusted to a pH of about 6.8 to 7.2 and crosslinked using a mild calcium source, for example 8 to 15 millimolar calcium chloride applied as a mist or bath after deposition. The resulting hydrogel exhibits a shear viscosity typically between 0.3 and 3 Pascal-seconds and an elastic modulus between 0.5 and 2 kilopascals prior to differentiation. These conditions maintain plant cell viability above 90 percent at densities of about 10⁵ to 10⁷ cells per milliliter and provide strong adhesion to the cellulose fibril network, which closely resembles the primary wall environment of living wood tissue.

For applications requiring induction of xylem or secondary-wall formation, the hydrogel may be modified to include phenylpropanoid precursors and oxidative enzymes that initiate lignification. In one embodiment, the formulation further comprises coniferyl and sinapyl alcohols at concentrations between 10 and 50 micromolar, together with laccase in the range of 1 to 5 units per milliliter or horseradish peroxidase in the range of 0.05 to 0.2 units per milliliter supplemented by a low concentration of hydrogen peroxide, for example 5 to 20 micromolar. Addition of a brassinosteroid such as 24-epibrassinolide at about 10 to 100 nanomolar may also be included to bias differentiation toward lignified xylem cell types. Over a maturation period of approximately one to two weeks, these additives gradually increase the hydrogel stiffness to values between 3 and 8 kilopascals and promote up-regulation of transcriptional cascades such as VND6 or VND7 followed by MYB46 and MYB83, leading to enhanced lignification and vessel-like structure formation.

In other embodiments, a softer and more elastic hydrogel variant may be prepared to favor phloem or bark-type differentiation. This variant may be produced by lowering the cellulose nanofiber content to between 0.3 and 0.6 percent and the alginate concentration to between 0.2 and 0.4 percent, while reducing calcium chloride to approximately 5 to 8 millimolar. In some cases, small amounts of gellan gum (0.05 to 0.1 percent) are included to stabilize the network. Differentiation toward phloem or periderm cell types can be enhanced by incorporation of abscisic acid at about 1 to 5 micromolar together with long-chain fatty alcohols or acids containing 16 to 24 carbon atoms at concentrations of 10 to 30 micromolar. These agents stimulate suberin biosynthesis through activation of MYB41 and MYB107 regulatory pathways, producing flexible, cork-like tissue. The resulting hydrogel typically exhibits an elastic modulus of 0.2 to 0.8 kilopascals, which supports phloem or periderm formation without extensive lignification.

In some embodiments, the stiffness of the hydrogel can be varied spatially within the printed construct to create continuous gradients that reproduce the native transition between xylem and phloem regions. Such gradients may be achieved by modulating cellulose nanofiber concentration or calcium exposure during deposition. Optionally, a thin bacterial-cellulose film having a thickness of about 20 to 80 micrometers may be laminated over the printed construct to serve as a breathable outer layer that enhances tensile strength, moisture buffering, and gas exchange.

In some embodiments, the disclosed hydrogel formulations maintain a near-neutral pH of about 7.0 and calcium concentrations not exceeding approximately 15 millimolar, ensuring compatibility with the Exomix vesicle formulations disclosed herein. Vesicles may be dispersed uniformly throughout the matrix or confined to discrete micro-reservoirs measuring approximately 0.5 to 1 millimeter in diameter to achieve controlled release of signaling molecules. The combination of cellulose-based fibrils, gentle ionic crosslinking, and balanced osmolarity provides a biologically relevant environment that supports both extracellular-vesicle diffusion and long-term plant-cell viability, thereby enabling reproducible formation of functional living wood tissue.

While preferred embodiments of the present inventions have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

Disclosed embodiments include the following examples;

### Example 1: Cork (Quercus suber) Regeneration Biomaterial

Title: Formation of a Cork-Mimicking Regenerative Biomaterial from Parenchyma Cells and Extracellular Vesicles (EVs) Following Wound Induction in Quercus suber.

### Field of the Example:

This example relates to regenerative biomaterials derived from plant cells and extracellular vesicles, specifically composites designed to replicate the structural and functional characteristics of natural cork (phellem). It demonstrates that parenchyma cells, their secreted EVs, and a suberin-compatible scaffold can undergo differentiation, suberization, and programmed cell death (PCD) to yield a functional cork-like material.

### Background and Biological Context:

Quercus suber regenerates outer bark after cork extraction via activation of underlying living tissues. Parenchyma and cambial cells beneath the wound plane dedifferentiate and redifferentiate to re-establish phellogen, which produces suberized, air-filled layers.

This physiological sequence, involving hormonal gradients, oxidative cues, EV-mediated communication, and terminal PCD can be emulated ex vivo using harvested cells, their EVs, and an appropriately engineered scaffold. The invention recreates this natural regeneration sequence within a controlled environment to yield a sustainable cork-mimicking biomaterial.

### Source of Biological Material:

Parenchyma cells are obtained from the inner surface of freshly harvested cork bark using gentle mechanical scraping and mild enzymatic digestion in isotonic buffer (PH˜5.8-6.0). The resulting cell suspension is washed and maintained under sterile conditions using standard plant tissue-culture techniques known in the art.

### Extracellular Vesicle (EV) Isolation:

EV release is promoted by maintaining parenchyma cells in liquid culture under controlled oxidative or hormonal stress. Conditioned media are clarified by filtration and concentrated/fractionated by tangential-flow filtration (TFF) or size-exclusion chromatography (SEC) to yield vesicles typically 50-250 nm in diameter with intact bilayers and monolayer characteristic suberin-precursor lipids.

### Scaffold Preparation:

Hydrogels of alginate, cellulose, or suberin-enriched polymer blends are prepared with 20-80 μm effective pore size. Hydrophobicity (contact angle) ˜95-105° and compressive modulus (target 0.5-1.5 MPa) are tuned to approximate cork's physical environment. Optional additives (e.g., glycerol esters or waxes) enhance suberin compatibility and mechanical stability.

### Assembly of the Composite:

Parenchyma cells (approximately 10⁴-10⁶ cells/cm³) and EVs (approximately 10⁹-10¹¹ particles/mL) are gently mixed with the scaffold and cast as slabs (2-6 mm) or cylindrical constructs. Incubation occurs at 22-28° C., 60-90% relative humidity, under diffuse light (e.g., 8-12 h photoperiod). The culture is maintained for a period sufficient to achieve differentiation, suberization, and structural stabilization, as detailed below.

### Differentiation and Maturation:

During incubation for a period sufficient to permit differentiation and maturation, the embedded cells undergo suberization characterized by deposition of lipidic and phenolic biopolymers, progressive dehydration, wall thickening, and partial programmed cell death, forming air-filled compartments.

Initiation phase: Visible suberization is expected within 2-8 weeks, depending on humidity, scaffold density, and nutrient exchange.

Maturation phase: Continued structural and biochemical maturation proceeds over 2-6 months, during which suberin lamellae consolidate, mechanical elasticity increases, and permeability decreases.

Stabilization phase: In certain embodiments, full cork-like tissue stabilization and property convergence occur over 3-12 months.

The maturation period is intentionally non-limiting; development may continue during long-term storage or after application to a substrate.

Optional, non-limiting maturation cues include:

Staged EV supplementation at early and mid-maturation phases.

Controlled dehydration and rehydration cycles to promote suberin lamellae consolidation.

Intermittent gentle compression or airflow to enhance gas exchange and mechanical alignment.

Light or temperature modulation to tune metabolic rate and maturation pace.

### Analytical Verification:

At one or more timepoints selected by the practitioner, formation of suberized and lignified layers is confirmed using established analytical techniques:

Spectroscopy: FTIR peaks at ˜1735 cm⁻¹ (C═O stretch), 2920 cm⁻¹ (CH₂ asymmetric stretch), and Raman aromatic bands near 1600-1630 cm⁻¹ confirm suberin and lignin formation.

Microscopy: Optical, confocal, and SEM imaging reveal layered, air-filled architecture typical of cork tissue.

Mechanical testing: Compressive modulus ˜0.5-1.2 MPa; elastic recovery >90%; gas permeability <1×10⁻⁶ cm²/s, consistent with natural cork.

Thermal stability: TGA/DSC shows degradation onset around 230-250° C.; moisture retention 5-7% at 50% RH.

EV analysis: NTA/DLS confirm size distribution centered near 120 nm; TEM shows intact vesicle morphology.

The timing and combination of analyses are determined by the practitioner and are not limiting to the invention.

### Result:

The composite biomaterial exhibits the elasticity, impermeability, and chemical features of native cork, with layered, suberized, air-filled cellular structures. Maturation over extended culture (up to several months) yields stable mechanical and barrier properties. Preparations without EV supplementation show slower or uneven suberization, demonstrating that EV-mediated communication enhances uniform differentiation.

The described system reproduces a biologically and chemically plausible pathway of cork tissue regeneration. A skilled person in plant biotechnology can perform the invention using commercially available materials and standard instruments. The invention demonstrates industrial applicability for sustainable insulation, packaging, and acoustic materials. The procedures and outcomes described are representing expected results consistent with known biological and materials-science principles. All biological materials used are derived from publicly available Quercus suber sources. No genetically modified or proprietary strains are required.

While the foregoing example employs Quercus suber as a representative source, the methods and compositions described herein are applicable to a wide variety of woody and vascular plant species. The processes of wound activation, extracellular-vesicle signaling, and suberization are conserved physiological responses among higher plants, including both angiosperms (e.g., Populus, Acer, Fagus, Betula) and gymnosperms (e.g., Pinus, Picea, Cedrus). The materials, steps, and environmental parameters disclosed may therefore be applied, with routine adjustment of incubation time, temperature, or humidity, to regenerate lignified, or suberized biomaterials from the parenchyma or cambial cells of any woody plant.

The fundamental mechanism underlying the invention, the extracellular-vesicle-mediated coordination of cellular differentiation and suberin or lignin deposition, is independent of species-specific genetic background. The same structural outcomes can be achieved in tissues derived from hardwoods, softwoods, and engineered or hybrid wood materials, provided the cells retain viability and metabolic capacity to produce secondary wall polymers. A person skilled in the art can, through routine optimization of nutrient medium, hormonal balance, and culture duration, adapt the disclosed procedure for any desired wood source without undue experimentation.

The invention thus provides a general regenerative platform for producing suberized or lignified biomaterials from plant sources. The ability to reproduce the essential regenerative architecture of cork and wood tissues across species establishes broad industrial applicability in fields such as sustainable material manufacturing, engineered wood composites, and bio-based protective coatings. Accordingly, the scope of the invention encompasses all woody and lignified plant species capable of cellular differentiation and extracellular-vesicle production under culture conditions as described.

### Example 2: Agarwood (Aquilaria spp.) Regenerative Biomaterial for Perfume Applications

Title: Formation of an Agarwood-Mimicking Regenerative Biomaterial Using Parenchyma and Resin-Secreting Cells Supplemented with Extracellular Vesicles (EVs) in a Scaffold Matrix.

### Field of the Example:

This example concerns the laboratory regeneration of fragrant, resinous tissue analogous to agarwood (Aquilaria or Gyrinops spp.).

It illustrates the use of living parenchyma and resin-forming cells, co-embedded with extracellular vesicles (EVs) in a lignin-compatible scaffold, to reproduce the wound-induced resignification process that naturally yields the aromatic wood known as agarwood or oud.

### Background and Biological Context:

In nature, Aquilaria trees form agarwood resin following mechanical injury or infection. Parenchyma and xylem-adjacent cells undergo oxidative stress that activates jasmonate- and ROS-dependent signaling, leading to production of sesquiterpenes and chromones. Secreted EVs enriched in defense enzymes (peroxidases, alcohol dehydrogenases, P450 mono-oxygenase) and regulatory RNAs mediate communication among cells, coordinating metabolic reprogramming and resin polymerization. Mimicking this cellular and vesicular interplay ex vivo permits sustainable agarwood-like biomaterial formation without tree destruction.

### Materials and Procedures:

Source of Cells: Cambial and parenchyma cells are harvested from Aquilaria malaccensis stems or from callus cultures initiated from sterilized explants. Cells are released by gentle enzymatic digestion (cellulase+pectinase) and maintained in modified Murashige-Skoog medium (2% sucrose; pH 5.8).

Extracellular Vesicle Isolation: Cell suspensions are exposed to 50 μM methyl jasmonate+1 mM H₂O₂ for 48 h to induce EV secretion. Conditioned medium is clarified (0.22 μm filtration) and concentrated by tangential-flow filtration (TFF) or size-exclusion chromatography (SEC). EVs (50-200 nm) contain terpenoid precursors, oxidoreductases, and small RNAs confirmed by NTA and TEM.

Scaffold Preparation: Porous hydrogels (alginate-lignin or cellulose-chitosan blends) are prepared with 30-100 μm pores and contact angle 85-110°. Optional 0.1-1% suberin or wax esters stabilize volatiles; ≤2% activated carbon or silica nanoparticles adsorb aromatic compounds. Target compressive modulus 0.4-1.0 MPa.

Assembly of Composite: Viable cells (10⁴-10⁶ cells cm⁻³) and EVs (10⁹-10¹¹ particles mL⁻¹) are mixed into the scaffold and cast as 3-6 mm slabs or pellets. Incubate at 25-28° C., 70-85% RH, low light (8 h photoperiod). Stress simulation is achieved by cyclic methyl jasmonate vapor exposure (12 h on/off) or temperature cycling 20-30° C.

### Differentiation, Resin Formation and Maturation:

Induction Phase (0-2 months): EV uptake initiates terpenoid pathways; medium amber-tinted. Maturation Phase (3-9 months): coordinated secretion and polymerization of sesquiterpenes and chromones within scaffold pores, forming resinous micro-domains.

Stabilization Phase (9-18 months): ** oxidative cross-linking yields a dark, aromatic composite. Optional enhancements: staged EV additions every 2 months, controlled dehydration/rehydration cycles, gentle aeration for oxygen-driven polymerization.

### Analytical Verification:

GC-MS: agarospirol, jinkoh-eremol, baimuxinal, oxo-agarospirol. LC-MS: chromones (agarotetrol, oxo-agarochromone). FTIR: aromatic C═C 1600-1660 cm⁻¹; carbonyl C═O 1710 cm⁻¹. Raman: conjugated aromatic bands 1570-1620 cm⁻¹. Microscopy: resin pockets within 30-80 μm pores. Mechanical: compressive modulus 0.4-0.9 MPa; elastic recovery >85%. Olfactometry: ≥80% similarity to commercial agarwood oil by electronic-nose GC pattern.

### Functional Verification and Reproducibility

Constructs yield consistent GC-MS profiles and aromatic intensity. EV-free controls show delayed resin formation and weaker fragrance, confirming EV-mediated activation. Comparable results from A. sinensis, A. crassna, and Gyrinops walla for validation of cross-species applicability.

Mechanistic Discussion: EVs transport sesquiterpene synthases, P450 enzymes, ROS-modulating proteins (SOD, CAT, POD), and miRNAs that up-regulate terpenoid biosynthetic genes. Within the scaffold, vesicle-cell crosstalk synchronizes metabolic activation and resin polymerization. The semi-hydrophobic matrix retains volatiles and supports gradual solidification. All steps are performable with routine plant-biotech methods, demonstrating enablement without undue experimentation.

Industrial and Environmental Relevance: The process provides a renewable route to agarwood-like perfume biomaterials independent of tree harvest. Products may serve as solid fragrance blocks, incense composites, or controlled-release aromatic devices, offering consistent quality and reduced environmental impact. The outcomes represent expected results consistent with known Aquilaria biology and EV-mediated signaling. Co-assembly of viable Aquilaria cells, their extracellular vesicles, and a supportive scaffold recapitulates the natural resignification process in vitro. The method is scientifically plausible, industrially applicable, and environmentally sustainable, extending the cell+EV+scaffold regenerative platform to olfactory and sensory biomaterials.

### Advantages of the Disclosed Embodiments:

Disclosed synthetic living wood tissue fabrication and restoration system provides a new class of bio-active, self-maintaining structural materials. Unlike conventional inert wood composites or static polymer coatings, the disclosed technology preserves metabolic activity within a fabricated plant-cell matrix and enables adaptive maintenance through extracellular-vesicle-mediated signaling. Without being bound by theory, such biological communication contributes to sustained material integrity under environmental stress.

Key advantages include:

Biological longevity—Embedded living plant cells and vesicle networks continuously exchange antioxidants, lipids, and structural precursors, thereby slowing oxidative degradation and extending the useful lifetime of treated wood substrates.

Self-healing capability—Localized mechanical or microbial damage induces vesicle release and lignification responses that reseal micro-cracks and inhibit decay.

Environmentally regenerative manufacturing—Fabrication proceeds under mild, aqueous conditions using renewable biomass inputs and minimal chemical additives.

Precision bio-fabrication—Additive manufacturing at 10-500 μm layer resolution enables vascular and microfluidic architectures that reproduce xylem and phloem organization.

Closed-loop control—Integrated impedance and chlorophyll-fluorescence sensors, together with environmental modules, maintain viability within +0.5° C. and +3% relative humidity.

Modular architecture—The Exomix and cell-source libraries support species-specific customization (e.g., oak-derived cork analogs and Aquilaria-derived aromatic composites).

Sustainable maintenance—Periodic supplementation via the maintenance subsystem sustains metabolic activity for extended periods, reducing material replacement frequency and waste.

### INDUSTRIAL APPLICATIONS

Wood preservation and restoration—Regeneration of historic or structural wood elements through in-situ growth of living replacement tissue.

Advanced composites—Incorporation of living wood laminates into engineered timber, flooring, or acoustic panels for adaptive damping and moisture regulation.

Luxury fragrance materials—Controlled production of Aquilaria-derived resinous panels or cork-based aromatic composites (see Example 2).

Smart packaging—Bio-responsive coatings capable of detecting humidity and releasing protective volatiles.

Architectural biomaterials—Additively manufactured decorative or structural elements exhibiting photosynthetic coloration and self-repair.

Disclosed system thereby enables an industrial transition from passive materials toward living regenerative infrastructure, combining the durability of engineered composites with the adaptive properties of biological systems.

What is claimed is:

1. A synthetic living wood tissue fabrication and restoration system comprising:
a) a formulation preparation subsystem configured to generate an Exomix, a bio-active plant-cell-based formulation;
b) an encapsulation unit configured to package an Exomix formulation into vesicles for controlled delivery;
c) an additive manufacturing subsystem arranged to deposit successive layers of the bio-ink to form a synthetic living wood tissue construct that incorporates niche reservoirs and a microfluidic channel network;
d) an environmental control module configured to maintain a controlled process environment of temperature, humidity, and gas composition suitable for plant cell viability during fabrication and post-fabrication maturation;
e) a maintenance and repair delivery subsystem operable to apply a maintenance material comprising the Exomix formulation to the synthetic living wood tissue construct after fabrication;
f) a control system comprising a processing unit and feedback loop circuitry configured to coordinate operation of the formulation preparation subsystem, the encapsulation unit, the additive manufacturing subsystem, the environmental control module, and the maintenance and repair delivery subsystem.

2. The synthetic living wood tissue fabrication and restoration system of claim 1, wherein the formulation preparation subsystem further comprises:
a) a cell source module configured to supply plant pluripotent cells and differentiated plant cells; and
b) an Exomix production module configured to blend proteins, RNAs, and lipids into a signaling cocktail.

3. The formulation preparation subsystem of claim 2, wherein the encapsulation unit further comprises:
a) a natural EV isolation stage configured to separate extracellular vesicles from conditioned plant cell and tissue culture medium; and
b) a synthetic EV fabrication stage configured to assemble phospholipid vesicles having diameters from 20 to 1000 nanometers around Exomix cargo.

4. The synthetic living wood tissue fabrication and restoration system of claim 1, wherein the additive manufacturing subsystem comprises:
a) a library storage subsystem comprising a cell library storage unit and an Exomix library storage unit configured to supply reference materials to the formulation preparation subsystem, and
b) a recoater assembly configured to spread successive layers of the bio-active plant-cell-based formulation with a thickness between 10 and 500 micrometers;
c) a build platform driven by a vertical translation mechanism; and
d) a formulation feed reservoir that is temperature-regulated.

5. The additive manufacturing subsystem of claim 4, wherein the environmental control module further comprising:
a) a sensors array; and
b) wherein the sensors array comprises impedance spectroscopy sensors and chlorophyll fluorescence sensors configured to monitor viability and function of the plant cell population within the synthetic living wood tissue construct; and
c) wherein the control system comprises feedback loop circuitry configured to maintain a controlled process environment with temperature within +0.5° C. of a setpoint and relative humidity within +3 percent of a setpoint.

6. The additive manufacturing subsystem of claim 4, wherein the maintenance and repair delivery comprises:
a) a spray/aerosol unit, an immersion chamber, and a channel injection probe that are selectable based on a geometry of a target.

7. A method of fabricating and maintaining synthetic living wood tissue, comprising:
a) preparing biological inputs including plant cells and an Exomix formulation;
b) formulating a bio-ink mixture from the biological inputs;
c) fabricating a synthetic living wood tissue construct by additive manufacturing of the bio-ink mixture;
d) integrating the synthetic living wood tissue construct with a wood substrate or repairing the wood substrate;
e) maintaining the living tissue by periodic supplementation; and
f) monitoring and controlling environmental and process variables throughout the foregoing steps.

8. The method of claim 7, wherein preparing biological inputs comprises:
a) isolating pluripotent plant cells from donor tissue;
b) expanding a pluripotent cell population in culture; and
c) inducing targeted differentiation of a subset of the pluripotent plant cells.

9. The method of claim 8, wherein preparing biological inputs further comprises:
a) generating an Exomix signaling cocktail by isolating extracellular vesicles from conditioned plant cell culture medium and synthesizing supplemental vesicle cargo; and
b) encapsulating the Exomix signaling cocktail within natural or synthetic vesicles.

10. The method of claim 7, wherein formulating the bio-ink mixture comprises:
a) combining the plant cells with the Exomix formulation;
b) adding a supportive hydrogel matrix; and
c) tuning a viscosity of the bio-ink mixture to a range between 0.3 and 3 Pascal-seconds while maintaining a post-processing cell viability greater than 90 percent.

11. The method of claim 7, wherein fabricating the synthetic living wood tissue construct includes:
a) depositing sequential layers having a thickness between 50 and 300 micrometers while maintaining a temperature between 20 and 30 degrees Celsius and a relative humidity greater than 70 percent.

12. The method of claim 11, wherein fabricating the synthetic living wood tissue construct further includes:
a) creating niche reservoirs that store Exomix formulation; and
b) forming microfluidic channels having widths between 100 and 500 micrometers to distribute nutrients.

13. The method of claim 11, wherein integrating the synthetic living wood tissue construct with the wood substrate or repairing the wood substrate comprises:
a) characterizing an application site for geometry, moisture content, and bio-ink/Exomix load;
b) delivering the bio-ink mixture to penetrate at least 5 millimeters into the wood substrate; and
c) maintaining the wood substrate at 60 to 95 percent relative humidity and at 18 to 32 degrees Celsius for 7 to 30 days to induce tissue integration.

14. The method of claim 13, wherein maintaining the living tissue comprises:
a) periodically applying a maintenance material that contains an Exomix-rich medium by spraying, immersion, or infusion.

15. The method of claim 13, further comprising:
a) monitoring cell viability in the synthetic living wood tissue construct using impedance spectroscopy and chlorophyll-fluorescence analysis; and
b) adjusting supplementation via feedback control based on results of the impedance spectroscopy and the chlorophyll-fluorescence analysis.

16. A synthetic living wood tissue construct comprising:
a) living plant cells retained within a supportive matrix;
b) discrete niche reservoirs that contain Exomix formulations;
c) an interconnected microfluidic channel network for nutrient distribution; and
d) wherein the synthetic living wood tissue construct exhibits at least one living-cell function selected from respiration, photosynthesis, and self-repair.

17. The synthetic living wood tissue construct of claim 16, wherein the living plant cells include both pluripotent stem cells and differentiated xylem and phloem cells, and
a) the differentiated cells exhibit characteristic features of vascular tissue, such as lignified secondary walls and sieve-tube-like morphology or expression of phloem-associated transport proteins.

18. The synthetic living wood tissue construct of claim 16, wherein each niche reservoir stores encapsulated Exomix vesicles having a diameter between 20 and 1000 nanometers and configured to provide controlled release of signaling molecules.

19. The synthetic living wood tissue construct of claim 16, wherein the microfluidic channel network comprises a dendritic arrangement of conduits having cross-sectional dimensions between approximately 50 and 500 micrometers, the network being configured to mimic xylem and phloem pathways for transport of fluids, gases, and extracellular vesicles within the construct.

20. The synthetic living wood tissue construct of claim 16, wherein the supportive matrix comprises a cellulose-nanofiber hydrogel integrated with extracellular vesicles or Exomix formulations that promote lignification and structural polymerization within the matrix, the construct thereby exhibiting increased mechanical strength, water resistance, and biological decay resistance.
